(19) United States
(12) Patent Application Publication
(10) Pub. No.: US 2026/0145439 A1
(43) Pub. Date: May 28, 2026

(54) INK JET RECORDING METHOD AND INK JET RECORDING APPARATUS

(71) Applicant: CANON KABUSHIKI KAISHA, Tokyo (JP)

(72) Inventors: MAMIKO KAJI, Kanagawa (JP); HIROSHI ASAKAWA, Kanagawa (JP); WAKA HASEGAWA, Tokyo (JP); AKIHIRO TAYA, Kanagawa (JP); HIDETAKA KAWAMURA, Kanagawa (JP); YUKO KATSUMOTO, Kanagawa (JP); KANAKO HIGUCHI, Kanagawa (JP)

(21) Appl. No.: 19/387,005

(22) Filed: Nov. 12, 2025

(30) Foreign Application Priority Data
Nov. 22, 2024 (JP) 2024-203723
Oct. 29, 2025 (JP) 2025-182972

(51) Int. Cl. B41J 11/00; B41J 2/21

(52) U.S. Cl. CPC B41J 11/002; B41J 2/2117

(57) ABSTRACT

An ink jet recording method includes a first ink applying step of applying a first ink to a low to non-absorbing recording medium, a drying step of drying at least a part of a liquid component of the first ink to form a first image, and a second ink applying step of applying a second ink to the first image to overlap at least a part of the first image to record the image. The first ink contains an inorganic particle and a first resin particle. The inorganic particle has a total pore volume of 0.03 cm³/g or more. The second ink contains a pigment. The second ink applying step is performed after a water absorption amount of the first image from the start of contact to 30 msec^{1/2} is set to 1.0 mL/m² or more by the drying step.

### BACKGROUND

### Field of the Technology

The present disclosure relates to an ink jet recording method and an ink jet recording apparatus.

### Description of the Related Art

In recent years, in the fields of commercial printing and the like, an ink jet recording method has been used to record an image of a white color on a recording medium of a color other than the white color, such as a transparent film, a translucent film or colored paper, using a white ink in some cases. In particular, in a case where a low to non-absorbing recording medium, which has low or no ink absorbency, is used, since the ink hardly permeates into the recording medium, image unevenness may occur due to the movement of the applied ink on the recording medium. Further, in a case where two or more kinds of inks are applied to the recording medium, the inks come into contact with each other, and thus bleeding may occur.

An ink jet recording method of recording an image, in which bleeding is suppressed by applying a reaction liquid containing an aggregating agent and a component that forms an ink receiving layer and two kinds of inks to a low to non-absorbing recording medium, has been suggested (Japanese Patent Laid-Open No. 2015-071738). Further, a printing method in which occurrence of bleeding is suppressed by controlling the surface tension of a white ink when an image is recorded by applying a chromatic color ink and a white ink to a film, which is a low to non-absorbing recording medium, has been suggested (Japanese Patent Laid-Open No. 2020-164571).

The present inventors have examined a recording method of applying a white ink and a non-white ink (chromatic color ink) in this order to a low to non-absorbing recording medium with reference to Japanese Patent Laid-Open Nos. 2015-071738 and 2020-164571. As a result, it has been found that image unevenness occurs in some cases.

### SUMMARY

Therefore, the present disclosure provides an ink jet recording method that suppresses occurrence of image unevenness in a case where a first ink which is a white ink and a second ink which is a non-white ink are applied in this order to a low to non-absorbing recording medium. Further, the present disclosure provides an ink jet recording apparatus used for the ink jet recording method.

That is, according to the present disclosure, there is provided an ink jet recording method of ejecting a first ink and a second ink, which are aqueous inks, from an ink jet type recording head to record an image on a recording medium in which a water absorption amount Wₘ from a start of contact to 30 msec^{1/2} is 10.0 mL/m² or less in a Bristow method, the ink jet recording method including: applying the first ink to the recording medium; drying at least a part of a liquid component of the first ink applied to the recording medium to form a first image; and applying the second ink to the first image to overlap at least a part of the first image to record the image, in which the first ink is a white ink containing an inorganic particle and a first resin particle, the inorganic particle has a total pore volume of 0.03 cm³/g or more, which is measured by a nitrogen adsorption and desorption method, the second ink contains a pigment and is an ink of a color different from the color of the first ink, and the applying of the second ink is performed after a water absorption amount W₁ of the first image from the start of contact to 30 msec^{1/2} is set to 1.0 mL/m² or more in the Bristow method by the drying of at least a part of the liquid component.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view for describing an example of a process of recording an image.

FIG. 2 is a schematic view for describing an example of the process of recording an image.

FIG. 3 is a side view schematically showing an embodiment of an ink jet recording apparatus according to the present disclosure.

FIG. 4 is a perspective view schematically showing an embodiment of the ink jet recording apparatus according to the present disclosure.

FIG. 5 is a side view schematically showing an embodiment of the ink jet recording apparatus according to the present disclosure.

### DESCRIPTION OF THE EMBODIMENTS

Hereinafter, the present disclosure will be described in more detail with reference to suitable embodiments. In the present disclosure, when a compound is a salt, the salt is present in an ink in a form of a dissociated ion, but the expression “containing a salt” is used for convenience. Further, an ink jet aqueous ink and an aqueous reaction liquid will also simply referred to as “ink” and “reaction liquid”. The physical property values are values at a normal temperature (25° C.) and a normal pressure (1 atm) unless otherwise specified. In the present disclosure, the density of an aqueous ink is defined as 1 g/cm³ (1 g/mL) for convenience. Hereinafter, an ink of a color different from a white ink will also be referred to as “non-white ink”. In the present disclosure, for convenience, the density of an aqueous ink is treated as 1 g/cm³ (1 g/mL).

The present inventors have examined a factor that causes image unevenness in an image recorded by applying a first ink which is a white ink and a second ink (non-white ink) which is an ink of a color different from the white ink in this order to a low to non-absorbing recording medium. Here, an aqueous white ink used for the ink jet recording method usually contains a coloring material suitable for forming a white ink and a resin particle for ensuring the strength of an image to be recorded, such as abrasion resistance. A white image to be recorded by applying a white ink to a recording medium is in a state where a coloring material is bound by a resin.

In a case where a non-white ink is applied to overlap a region where a white ink is applied, to record an image of a non-white color on a white background, a liquid component of the non-white ink is unlikely to permeate into a white ink layer, and convection and evaporation of the liquid component of the non-white ink are likely to occur on the white ink layer. Further, the white ink layer repels the non-white ink so that the coloring material of the non-white ink is likely to move from an intended position. Due to these factors, unevenness is considered to easily occur in an image to be recorded by applying a non-white ink to overlap a region where a white ink is applied. In particular, in a case where a low to non-absorbing recording medium in which the water absorption amount from the start of contact to 30 msec^{1/2} is 10.0 mL/m² or less in a Bristow method is used, the liquid component of the non-white ink is unlikely to be absorbed not only on the white ink layer but also on the recording medium. Therefore, image unevenness significantly occurs.

The present inventors have examined a configuration of an ink jet recording method that suppresses occurrence of image unevenness in a case where a white ink and a non-white ink are applied in this order to a low to non-absorbing recording medium to record an image. As a result, it has been found that the occurrence of image unevenness can be suppressed by satisfying the following requirements (i) to (iv), thereby completing the present disclosure.
(i) The ink jet recording method includes a first ink applying step of applying a first ink to a recording medium and a second ink applying step of applying a second ink to the recording medium to overlap at least a part of a region where the first ink is applied (this region is “first image” in the item (iv) described below), to record an image.
(ii) The first ink is a white ink containing an inorganic particle and a first resin particle, and the inorganic particle has a total pore volume of 0.03 cm³/g or more, which is measured by a nitrogen adsorption and desorption method.
(iii) The second ink contains a pigment and is an ink of a color different from the color of the first ink.
(iv) The ink jet recording method includes a drying step of drying at least a part of a liquid component of the first ink applied to the recording medium to form a first image after the first ink applying step. Further, the second ink applying step is performed after a water absorption amount W₁ (mL/m²) of the first image from the start of contact to 30 msec^{1/2} is set to 1.0 mL/m² or more in the Bristow method by the drying step.

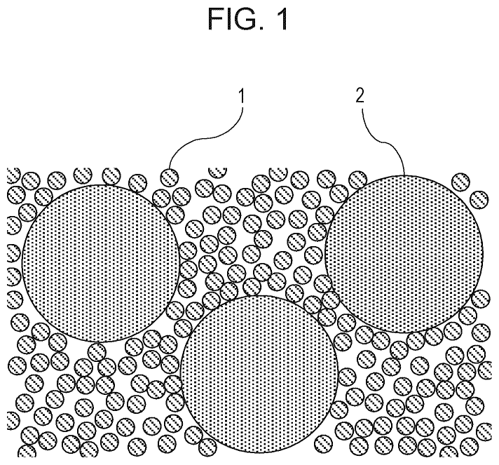

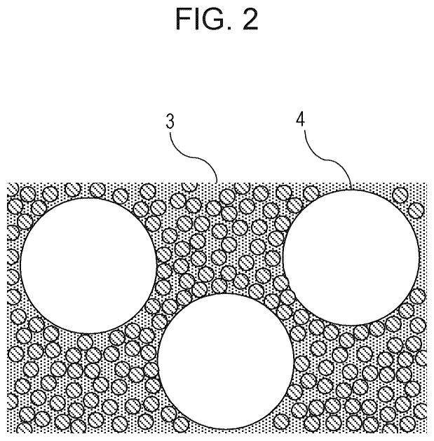

FIGS. 1 and 2 are schematic views for describing an example of the process of recording an image. The first ink which is a white ink contains an inorganic particle 1 having a total pore volume of 0.03 cm²/g or more, which is measured by a nitrogen adsorption and desorption method, and a first resin particle 2. When the first ink is applied to a recording medium, an ink film in which the inorganic particle 1 and the first resin particle 2 in the ink are densely packed is formed as shown in FIG. 1. Thereafter, at least a part of the liquid component of the first ink applied to the recording medium is reduced by being dried in the drying step. The inorganic particle 1 is a porous particle having a total pore volume of 0.03 cm³/g or more, which is measured by a nitrogen adsorption and desorption method. When at least a part of the liquid component of the first ink is reduced in the drying step, the liquid component held by the porous particle is reduced, and thus a gap derived from the inorganic particle 1, which is a porous particle, is generated in the ink film to be formed of the first ink on the recording medium. Further, since the first ink contains the first resin particle, the content of the solid content in the first ink increases but the amount of the liquid component in the first ink decreases as compared with a case where the resin particle is not present. These effects combine to increase the efficiency of the drying step and to rapidly reduce the amount of the liquid component from the ink film to be formed of the first ink on the recording medium. In this manner, a first image to be formed by drying at least a part of the liquid component of the first ink is likely to newly absorb the liquid component due to the gap derived from the inorganic particle.

Next, the second ink containing a pigment is applied to overlap at least a part of the first image. Here, the first image is required to have a water absorption amount W₁ of 1.0 mL/m² or more from the start of contact to 30 msec^{1/2} in the Bristow method. The first image satisfying this requirement is likely to absorb the liquid component, and thus the liquid component of the second ink applied to the first image is rapidly absorbed by the gap derived from the inorganic particle in the first image. As a result, since the pigment concentration of the second ink and the viscosity of the ink are drastically increased, the second ink is unlikely to be repelled by the first image, the movement of the pigment is suppressed, and therefore, occurrence of the image unevenness can be suppressed. Meanwhile, when the water absorption amount W₁ from the start of contact to 30 msec^{1/2} is less than 1.0 mL/m² in the Bristow method, the first image cannot rapidly absorb the liquid component of the second ink, and thus the second ink is likely to be repelled by the first image. Therefore, the movement of the pigment cannot be suppressed, and as a result, the image unevenness occurs.

In the recording methods described in Japanese Patent Laid-Open Nos. 2015-071738 and 2020-164571, it is considered that since the water absorption amount of the white ink layer is small, the liquid component of the chromatic color ink is unlikely to be absorbed, and thus the image unevenness occurs. The reason the water absorption amount of the white ink layer is small is that the amount of the inorganic particle of the white ink is small and the application amount of the ink is also small.

### Ink Jet Recording Method and Ink Jet Recording Apparatus

The ink jet recording method of the present disclosure is a method of ejecting a first ink and a second ink, which are aqueous inks, from an ink jet type recording head to record an image on a low to non-absorbing recording medium. A water absorption amount Wₘ (mL/m²) of the low to non-absorbing recording medium from the start of contact to 30 msec^{1/2} is 10.0 mL/m² or less in the Bristow method. The method includes the following steps: a first ink applying step of applying the first ink to the recording medium, a drying step of drying at least a part of a liquid component of the first ink applied to the recording medium to form a first image, and a second ink applying step of applying the second ink to the first image to overlap at least a part of the first image to record the image. The first ink is a white ink containing an inorganic particle and a first resin particle, and the inorganic particle has a total pore volume (cm³/g) of 0.03 cm³/g or more, which is measured by a nitrogen adsorption and desorption method. Further, the second ink contains a pigment and is an ink of a color different from the color of the first ink. In addition, the second ink applying step is performed after a water absorption amount W₁ (mL/m²) of the first image from the start of contact to 30 msec^{1/2} is set to 1.0 mL/m² or more in the Bristow method by the drying step.

An ink jet recording apparatus of the present disclosure is an apparatus that ejects the first ink and the second ink, which are aqueous inks, from an ink jet type recording head to record an image on a recording medium and that is suitably used for the recording method described above. In the present disclosure, it is not necessary to provide a step of irradiating the image with an active energy ray or the like to cure the image.

Hereinafter, the ink jet recording method and the ink jet recording apparatus (hereinafter, also simply referred to as “the recording method and the recording apparatus”) of the present disclosure will be described in detail.

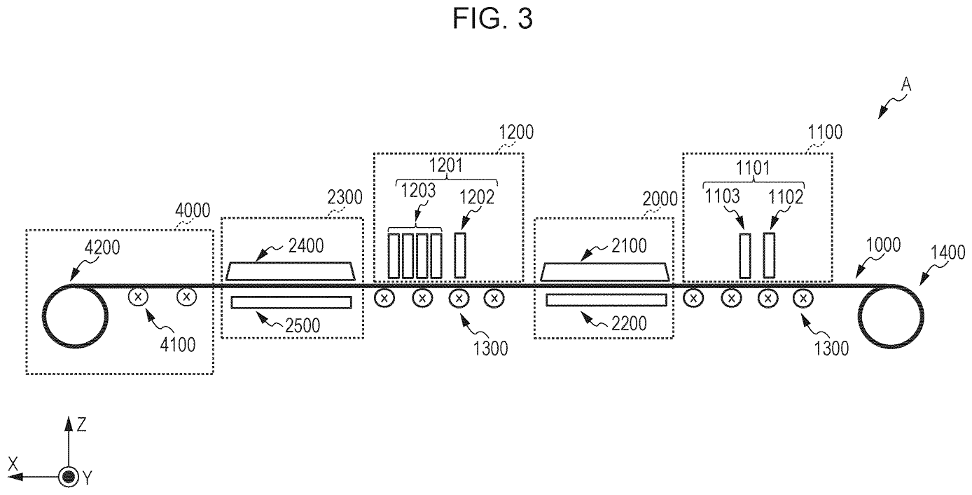

FIG. 3 is a side view schematically showing an embodiment of the ink jet recording apparatus according to the present disclosure. An ink jet recording apparatus A in the form shown in FIG. 3 is an ink jet recording apparatus that records an image on a recording medium wound in a roll shape using an ink and a reaction liquid containing a reactant that reacts with the ink. An X direction, a Y direction and a Z direction respectively denote a width direction (total length direction), a depth direction and a height direction of the ink jet recording apparatus. The recording medium is conveyed in the X direction.

The ink jet recording apparatus A according to the embodiment shown in FIG. 3 is configured to include a first recording unit 1100, a first drying unit 2000, a second recording unit 1200, a second drying unit 2300 and a paper discharge unit 4000. In the first recording unit 1100, various liquids including the first ink are applied to record a white image by a first liquid applying device 1101 to a recording medium 1000 conveyed by a conveyance member 1300 from a feeding device 1400 (first ink applying step). In the first drying unit 2000, the recording medium 1000 is conveyed along a first conveyance member 2200 while the tension is maintained. Here, in the first drying unit 2000, the liquids including the first ink applied to the recording medium 1000 are dried by blowing air from the first drying device 2100, and the liquid component, such as water, in the ink is evaporated to dry the recording medium 1000 (drying step).

In the second recording unit 1200, various liquids including the second ink are applied onto a white background by a second liquid applying device 1201 to record a non-white image in the same manner as that for the first ink (second ink applying step). In the second drying unit 2300, the recording medium 1000 is conveyed along a second conveyance member 2500 while the tension is maintained. Here, in the second drying unit 2300, the liquid including the second ink applied to the recording medium 1000 is dried by blowing air or the like from the second drying device 2400, and the liquid component, such as water, in the ink is evaporated to dry the recording medium 1000. Although not shown in FIG. 3, a cooling step of cooling the recording medium 1000 may be further performed after the drying step performed by the first drying unit 2000 and the second drying unit 2300.

The recording medium 1000 on which an image has been recorded is conveyed while being supported by a support member 4100 in the paper discharge unit 4000, and is wound up by a winding device 4200. The recording apparatus shown in FIG. 3 is configured to record an image on a roll-shaped recording medium, but the recording medium is not limited to a roll shape, and a sheet-shaped recording medium can also be used by changing the method of conveying the recording medium and the paper discharge device.

### Recording Unit

The recording unit is configured to include the first recording unit 1100 that applies a liquid including the first ink and the second recording unit 1200 that applies a liquid including the second ink. The first recording unit 1100 includes the first liquid applying device 1101. The first liquid applying device 1101 is configured to include the first reaction liquid applying device 1102 and the first ink applying device 1103. The second recording unit 1200 includes the second liquid applying device 1201. The second liquid applying device 1201 is configured to include the second reaction liquid applying device 1202 and the second ink applying device 1203.

The first reaction liquid applying device 1102 and the second reaction liquid applying device 1202 shown in FIG. 3 are examples of units formed of an ink jet type ejection head. In addition, the reaction liquid applying device may be configured by using a gravure coater, an offset coater, a die coater, a blade coater or the like. The application methods for the first reaction liquid applying device 1102 and the second reaction liquid applying device 1202 may be the same as or different from each other. The application of the reaction liquid s using the first reaction liquid applying device 1102 and the second reaction liquid applying device 1202 may be performed before or after the application of the ink as long as the reaction liquid can be brought into contact with the ink on the recording medium 1000. Here, the reaction liquids can be applied before the application of the ink in order to record a high-quality image on various recording media with different liquid absorption properties. An ink jet type ejection head (recording head) is used as the first ink applying device 1103 and the second ink applying device 1203. Examples of an ejection method for the ejection head of the first liquid applying device 1101 and the ejection head of the second liquid applying device 1201 include a method of ejecting a liquid by causing film boiling in the liquid using an electrothermal converter to form air bubbles and a method of ejecting a liquid using an electromechanical converter. The ejection methods for the first ink applying device 1103 and the second ink applying device 1203 may be the same as or different from each other. Further, the first reaction liquid used in combination with the first ink and the second reaction liquid used in combination with the second ink may be the same as or different from each other.

The first liquid applying device 1101 and the second liquid applying device 1201 are line heads extending in the Y direction, and ejection orifices are arranged in a range where an image recording area of the available recording medium with the maximum width is covered. The ejection head on a lower side (recording medium 1000 side) has an ejection orifice surface having an ejection orifice formed therein, and the ejection orifice surface faces the recording medium 1000 with an extremely small distance of several millimeters.

Hereinafter, an example in which the first ink is ejected from the first ink applying device 1103 and the second ink is ejected from the second ink applying device 1203 will be described. A plurality of the second ink applying devices 1203 may be provided to apply inks of different colors to the recording medium 1000. For example, in a case where an image of each color is recorded using a yellow ink, a magenta ink, a cyan ink and a black ink as the second ink, four second ink applying devices 1203 that eject these four types of inks are arranged side by side in the X direction. The color tone and application order of the first ink and the second ink are not limited to those described above. Hereinafter, the ink and the reaction liquid will also be collectively referred to as “liquid”.

### Conveyance System

As shown in FIG. 3, the first recording unit 1100 is configured to include the first liquid applying device 1101 and the conveyance member 1300 that conveys the recording medium 1000. The reaction liquid and the ink are applied by the first liquid applying device 1101 to a desired position of the recording medium 1000 to be conveyed by the conveyance member 1300. The first reaction liquid applying device 1102 and the first ink applying device 1103 receive an image signal of recording data and apply the reaction liquid and the ink respectively to the desired position. Further, the second recording unit 1200 is configured to include the second liquid applying device 1201 and the conveyance member 1300 that conveys the recording medium 1000, and applies the reaction liquid and the ink to a desired position similarly to the first recording unit 1100.

In a case where the recording medium 1000 has a sheet shape, a conveyance member capable of fixing and conveying the recording medium 1000 can be used as the conveyance member 1300. Specific examples of a method of fixing and conveying the recording medium include a method of providing a hole in the conveyance member 1300 using a conveyance belt, a spur or a conveyance cylinder and suctioning the recording medium 1000 from the rear surface side thereof to fix the recording medium 1000 and a method of forming the conveyance member 1300 using an appropriate material and electrostatically adsorbing the recording medium 1000 to fix the recording medium 1000.

### Drying Unit

As shown in FIG. 3, the first drying unit 2000 is configured to include the first drying device 2100 and the first conveyance member 2200. Similarly, the second drying unit 2300 is configured to include the second drying device 2400 and the second conveyance member 2500. In the first drying unit 2000, the liquid component of the first ink is dried by the first drying device 2100 while the recording medium 1000 to which the first ink has been applied is conveyed by the first conveyance member 2200, to evaporate the liquid component in the ink. Further, in the second drying unit 2300, the liquid component of the second ink is dried by the second drying device 2400 while the recording medium 1000 to which the first ink and the second ink have been applied is conveyed by the second conveyance member 2500 to evaporate the liquid component in the ink. The drying step is not required to evaporate the entire liquid component in the second ink.

The first drying device 2100 and the second drying device 2400 may have any configuration as long as at least a part of the liquid component on the recording medium 1000 can be dried, and known devices, for example, a blowing device such as a fan or a heating device such as a heater can be used. The liquid components of the first ink and the second ink can be more efficiently dried by drying the recording medium 1000 while heating the same. In a case where a device capable of performing heating is used as a drying device, a non-contact type heater such as a heating wire or an infrared ray can be suitably used from the viewpoint of the safety or energy efficiency. When heated air is sent to the recording medium 1000 by fans that are built in the first drying device 2100 and the second drying device 2400, the drying efficiency can be further enhanced. In consideration of the conveyance speed and the environment temperature, the conditions such as the temperature of the drying unit can be set such that the recording medium reaches a desired temperature.

In a case where the first drying device 2100 and the second drying device 2400 are equipped with a blowing device, air can be blown from the surface (recording surface (front surface)) side of the recording medium 1000 to which the liquid has been applied. Further, in a case where the first drying device 2100 and the second drying device 2400 are devices capable of performing heating, heating may be performed from the front surface side, the rear surface side, or both surfaces of the recording medium 1000. Further, the first conveyance member 2200 and the second conveyance member 2500 may have a function of performing heating.

In a case where the recording medium 1000 is dried while being heated in the first drying unit 2000 and the second drying unit 2300, the recording medium 1000 can be heated at a temperature T_{H} (° C.) higher than or equal to a glass transition temperature Tg (° C.) or a melting point Tm (° C.) of the first resin particle in order to melt the first resin particle of the first ink. That is, a drying temperature T_{H} (° C.) can be set according to the glass transition temperature Tg (° C.) or the melting point Tm (° C.) of the first resin particle. In a case where the first resin particle is a crystalline resin, the first resin particle has a glass transition temperature Tg (° C.) and a melting point Tm (° C.), and thus the recording medium can be heated at a temperature higher than or equal to the melting point Tm (° C.) in order to melt the first resin particle. Specifically, the drying temperature T_{H} (C) in the first drying unit 2000 can be 70° C. or higher, 80° C. or higher or 90° C. or higher. The drying temperature T_{H} (° C.) can also be set to 200° C. or lower, 150° C. or lower or 130° C. or lower from the viewpoint of the upper temperature limit of the recording medium. Further, the drying temperature T_{H} (° C.) can also be set to a temperature lower than the glass transition temperature Tg (° C.) or the melting point Tm (° C.) of the inorganic particle 1.

The drying temperature T_{H} (° C.) denotes the maximum temperature of the recording medium (surface) reaching in the drying step. The drying temperature T_{H} (° C.) can be measured by using, for example, a contact type thermometer in which a thermocouple or the like is brought into contact with the recording medium or a non-contact type infrared thermometer. In examples described below, the temperature of the surface of the recording medium is measured at a position with a distance of 10 cm, which is oriented vertically to the surface of the recording medium using a non-contact thermometer (product name: “non-contact infrared thermometer digital radiation temperature sensor FT-H20”, manufactured by Keyence Corporation).

FIG. 2 is a schematic view for describing an example of the process of recording an image in a case where the drying temperature T_{H} (C) is set to be higher than or equal to the glass transition temperature Tg (° C.) or the melting point Tm (° C.) of the first resin particle. The first resin particle 2 is melted by setting the drying temperature T_{H} (C) to be higher than or equal to the glass transition temperature Tg (° C.) or the melting point Tm (° C.) of the first resin particle. The resin generated by the melting of the first resin particle 2 permeates into the gap derived from the inorganic particle 1, and a hole 4 is formed at a site where the first resin particle 2 is present (FIG. 2). The inorganic particle 1 is not melted when the drying temperature T_{H} (C) is lower than the glass transition temperature Tgₜ (° C.) or the melting point Tm (° C.) of the inorganic particle 1. The resin generated by the melting of the first resin particle permeates into the hole derived from the inorganic particle 1 to form a binder 3 which is a mixture of the particle 1 and the melted particle. A white image recorded as described above has the hole 4 therein. Since the air present in the hole 4 has a low refractive index, incident light is scattered due to a difference in refractive index between the binder 3 and the hole 4, and thus a white image with a high concealing property can be obtained.

### Paper Discharge Unit

The recording medium 1000 after an image is recorded thereon is accommodated in the paper discharge unit 4000 (FIG. 3). The recording medium 1000 that passes through the first drying unit 2000 after recording is performed by the first recording unit 1100 and then passes through the second drying unit 2300 after recording is performed by the second recording unit 1200 is conveyed by the conveyance member 4100. The recording medium 1000 is finally accommodated in a state where the recording medium 1000 is wound up in a roll shape by a paper discharge device 4200. Two or more paper discharge devices 4200 may be provided to respectively accommodate different recorded materials.

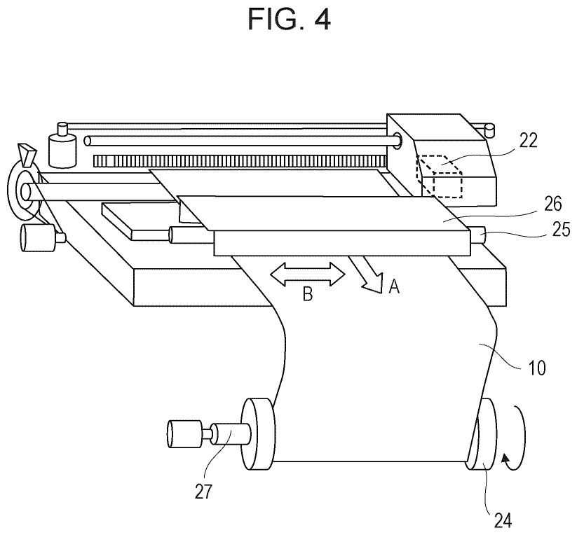

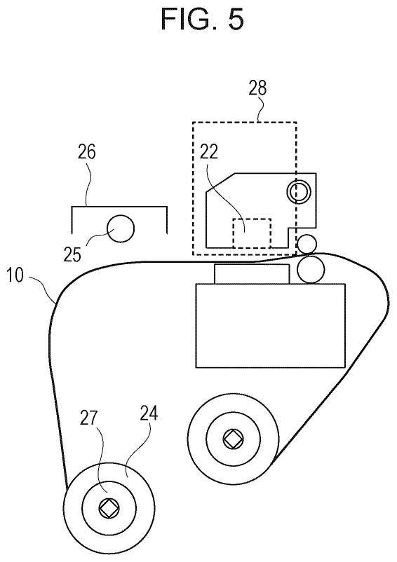

FIG. 4 is a perspective view schematically showing an embodiment of an ink jet recording apparatus different from the ink jet recording apparatus shown in FIG. 3. FIG. 5 is a side view of FIG. 4. The recording apparatus according to the embodiment shown in FIGS. 4 and 5 includes an ink jet type recording head 22 that ejects an ink. The recording head may include a mechanism (temperature adjustment mechanism) that heats an aqueous ink ejected from the recording head. In a case where the recording head includes a temperature adjustment mechanism, the heating temperature of the ink ejected from the recording head can be 35° C. or higher to 70° C. or lower.

The ink jet recording apparatus shown in FIG. 4 can perform so-called multipass recording in which the ink is applied to a unit area of the recording medium by relative scanning performed a plurality of times on the recording head and the recording medium. The unit area can be set as any area such as one pixel or one band. This apparatus can apply the first ink and the second ink to the unit area of the recording medium by performing different relative scanning respectively. In this manner, this allows an interval of time until the first ink and the second ink come into contact with each other, at least a part of the liquid component of the first ink is dried, and accordingly, an increase in the water absorption amount W₁ (mL/m²) to 1.0 mL/m² or more can be easily achieved.

A drying device (FIG. 5) for performing the drying step is provided on an upstream side or a downstream side of a recording medium 10 in a conveyance direction intersecting with a main scanning direction in which the recording head 22 reciprocally scans. At least a part of the liquid component of the first ink is dried by a drying device 28 after the first ink is applied to the recording medium 10 and before the second ink is applied to the recording medium 10 (drying step). The drying step is not required to dry the entire liquid component of the first ink, and is not limited as long as the water absorption amount W₁ (mL/m²) when the second ink is applied to the first image where at least a part of the liquid component is evaporated is 1.0 mL/m² or more. The drying device 28 may have any configuration as long as the evaporation of the liquid component of the first ink on the recording medium 10 can be promoted, and known devices such as an air blowing devices including fans, or heating devices such as heaters, can be used. The heating temperature T_{H} (° C.) in the drying may be set in the same manner as in the case of the ink jet recording apparatus shown in FIG. 3.

In the recording apparatus shown in FIGS. 4 and 5, a heater 25 supported by a frame (not shown) is disposed on a downstream side of the recording medium 10 in a sub-scanning direction A with respect to a position where the recording head 22 reciprocally scans in a sub-scanning direction B so that the recording medium 10 to which the ink has been applied is heated by the heater 25. Examples of the heater 25 include a sheathed heater and a halogen heater. The heater 25 is covered by a heater cover 26. The heater cover 26 is a member for efficiently irradiating the recording medium 10 with heat generated from the heater 25. The heater cover 26 is also a member that protects the heater 25. After the application of the second ink, the liquid component in the ink is evaporated by the heater 25 to dry the image. The drying temperature T_{H} (° C.) may be set in the same manner as in the case of the ink jet recording apparatus shown in FIG. 3.

The recording medium 10 on which an image has been recorded is wound up by a winding spool 27 to form a roll-shaped winding medium 24. The recording medium shown in FIGS. 4 and 5 is configured to record an image on a roll-shaped recording medium, but the recording medium is not limited to a roll shape, and a sheet-shaped recording medium can also be used by changing the method of conveying the recording medium and the paper discharge device.

### Recording Medium

A low-absorbing or non-absorbing recording medium (low to non-absorbing recording medium) is used as the recording medium. In the present specification, “low to non-absorbing recording medium” is a recording medium in which the water absorption amount Wₘ (mL/m²) from the start of contact to 30 msec^{1/2} is 10 mL/m² or less in the Bristow method. The Bristow method is a method that has been widely used as a method of measuring a liquid absorption amount in a short period of time, and is also employed in Japan Technical Association Of The Pulp And Paper Industry (JAPAN TAPPI). The details of the test method are described in Standard No. 51 “Paper and Paperboard, Liquid Absorbency Test Method, Bristow Method” of “Paper and Pulp Test Method of JAPAN TAPPI (2000 edition)”. A recording medium (glossy paper, mat paper or the like) provided with an ink receiving layer for ink jet recording or plain paper having no coating layer is “absorbing recording medium” having a water absorption amount Wₘ of more than 10 mL/m².

Examples of the low-absorbing recording medium include a recording medium having no ink receiving layer and a recording medium having a thin ink receiving layer. Examples of such a recording medium include printing paper such as art paper, high-quality coated paper, medium-quality coated paper, high-quality lightweight coated paper, medium-quality lightweight coated paper, fine coated paper and cast coated paper. Further, examples of the non-absorbing recording medium include a recording medium having no ink receiving layer and a recording medium having a thin ink receiving layer. Examples of such a recording medium include a plastic film and a base material, such as paper, coated with plastic. Examples of the plastic include polyvinyl chloride, polyethylene terephthalate, polycarbonate, polystyrene, polyurethane, polyethylene and polypropylene. Other examples thereof include glass, a metal and a ceramic. Among these, a plastic film or a base material, such as paper, coated with plastic can be used. In the present specification, the term “recording medium” does not denote a transfer body, but denotes a target on which an image is recorded as a recorded material.

Since the first ink is a white ink that can record an image of a white color or the like, a recording medium of a color other than the white color, such as a transparent film, a translucent film or colored paper, can be used. The term “white color” here has the same properties as those of “white color” of the first ink described below.

### First Ink

The first ink used in the recording method is an ink jet aqueous white ink containing the inorganic particle and the first resin particle. Here, the white ink includes an ink capable of recording a white image even when the ink does not exhibit a white color in an ink state. The white color denotes that the brightness (L*) and the chromaticity (a*, b*) in the CIEL*a*b* color specification system are respectively in ranges of 70≤L*≤100, −4.5≤a*≤2.0 and −6.0≤b*≤2.5. Hereinafter, the components and the like constituting the ink will be described in detail.

### Inorganic Particle

The first ink contains the inorganic particle. The inorganic particle may be a coloring material or a particle that does not exhibit a color, such as a resin particle. Among such particles, since a white image is recorded, a colorless or white inorganic particle can be used. The inorganic particle is required to have a total pore volume of 0.03 cm³/g or more, which is measured by a nitrogen adsorption and desorption method. The total pore volume of the inorganic particle is determined by an adsorption and desorption isotherm of nitrogen gas, which is measured by a nitrogen adsorption and desorption method. The total pore volume of the inorganic particle can be 0.20 cm³/g or more. Further, the total pore volume of the particle can be 1.00 cm³/g or less, or 0.80 cm³/g or less.

### Content

A content V_{I} (% by volume) of the inorganic particle in the first ink can be 1.5% by volume or more to 5.0% by volume or less with respect to the total volume of the ink. Further, a content C_{I} (% by mass) of the inorganic particle in the first ink can be 5.0% by mass or more to 45.0% by mas or less, or 5.0% by mass or more to 40.0% by mass or less with respect to the total mass of the ink.

### Particle Diameter

The inorganic particle is usually dispersed in the ink in the form of a secondary particle obtained by aggregation of two or more primary particles. The inorganic particle can have an average primary particle diameter D_{I} (nm) of 150 nm or less, 50 nm or less or 30 nm or less. The inorganic particle can have an average primary particle diameter D_{I} (nm) of 5 nm or more. The average primary particle diameter of the inorganic particle can be measured by observing the inorganic particle using a scanning electron microscope. The average primary particle diameter D_{P0} (nm) of the inorganic particle can be calculated as an average value of the primary particle diameters of a plurality of the inorganic particles (for example, 100 particles).

The inorganic particle is usually dispersed in the ink in a state of secondary particles obtained by aggregation of two or more primary particles. Since the inorganic particle with a small volume-based cumulative 50% particle diameter D50ₜ (nm) is unlikely to scatter visible light, the concealing property of a white image to be recorded with the first ink is likely to be degraded in some cases when the first ink containing such an inorganic particle is used. Further, the color developability of a color image recorded with the second ink on the white image recorded with the first image (hereinafter, also referred to as “non-white image on the white background”) is likely to be degraded in some cases. However, since the inorganic particle having a total pore volume of 0.03 cm³/g or more, which is measured by a nitrogen adsorption and desorption method, is a porous material, the air contained in the pore of the inorganic particle has a high refractive index, and thus scattering of visible light occurs. In this manner, the concealing property of the image to be recorded with the first ink is likely to be enhanced. Further, the color developability of the non-white image on the white background is also likely to be enhanced. In addition, the first resin particle is melted by performing heating at the temperature T_{H} (° C.) higher than or equal to the glass transition temperature Tg (° C.) or the melting point Tm (° C.) of the first resin particle in the drying step so that the hole is generated as described above. The incident light can be efficiently scattered by this hole, and therefore, the concealing property of the image to be recorded with the first ink and the color developability of the non-white image on the white background can be further improved.

The volume-based cumulative 50% particle diameter D50_{I} (nm) of the inorganic particle can be 5 nm or more to 250 nm or less, or 5 nm or more to 200 nm or less. In the present specification, the expression “volume-based cumulative 50% particle diameter” denotes the diameter of the particle that is 50% of the total volume of the measured particle in the particle diameter cumulative curve when accumulated from a small particle diameter side, and can be measured with a particle size distribution measuring device using a dynamic light scattering method. The measurement can be performed under conditions of, for example, a Set-Zero of 30 seconds, the number of times of measurement of 3 times and a measurement time of 180 seconds in an aspherical shape. Further, a particle size analyzer (for example, trade name “UPA-EX150”, manufactured by Nikkiso Co., Ltd.) or the like using a dynamic light scattering method can be used as a particle size distribution measuring device. Further, the particle size distribution measuring device to be used, the measurement conditions and the like are not limited to those described above.

### Density

The density of the particle can be the same as or more than the density of the first resin particle. Here, the density of the particle is suitably more than the density of the first resin particle. Further, the density ρ₁ (g/cm³) of the particle can be 1.00 g/cm³ or more to 5.00 g/cm³ or less, 2.00 g/cm³ or more to 5.00 g/cm³ or less, or 4.00 g/cm³ or more to 5.00 g/cm³ or less.

### Refractive Index

The inorganic particle forms a part of the material constituting a white ink layer (binder), and thus a particle having a high refractive index can be used. Specifically, the refractive index of the inorganic particle can be 2.0 or more to 3.0 or less. Among such particles, titanium oxide having a relatively high refractive index can be used as the inorganic particle. The refractive index of titanium oxide can be 2.1 or more, or 2.5 or more to 2.8 or less.

### Suitable Materials

The inorganic particle can be a white pigment. Specific suitable examples thereof include titanium oxide, calcium carbonate, aluminum oxide, calcium phosphate, barium sulfate, zirconium oxide, silicon dioxide, kaolin, clay, magnesium carbonate, calcium sulfate, magnesium sulfate, calcium hydroxide, magnesium hydroxide, aluminum silicate, magnesium silicate, zinc oxide, synthetic amorphous silica, colloidal silica, wet silica and dry silica. Among these, a white pigment such as titanium oxide, calcium carbonate or aluminum oxide is suitable, and titanium oxide is more suitable.

The titanium oxide is present in three crystal forms, which are a rutile type, an anatase type and a brookite type. Among these, rutile type titanium oxide with a low photocatalytic activity can be used. Examples of an industrial method of producing titanium oxide include a sulfuric acid method and a chlorine method, and titanium oxide produced by either production method can be used. The particle surface of the titanium oxide may be coated with alumina or zirconia. Further, the particle surface of the titanium oxide may be coated with an inorganic oxide such as silica, zinc oxide, or zirconia, or an organic substance such as a polyol. When titanium oxide having a particle surface coated with such a material is used, the photocatalytic activity is expected to be suppressed, and the dispersibility is expected to be improved. The calcium carbonate has a cubic or spindle particle shape. Between these, calcium carbonate having a uniform cubic shape can be used. Examples of the aluminum oxide include α-alumina, γ-alumina and nano alumina.

Examples of a method of dispersing the inorganic particle include a method of dispersing the inorganic particle by applying energy (mechanical or thermal) to a liquid medium containing the inorganic particle. Further, from the viewpoint of stably maintaining the dispersion state of the inorganic particle, a dispersant can be used. For example, a cationic resin can be used as the dispersant for an inorganic particle, such as dry-process silica, which has a low isoelectric point and a negative electric charge of the particle surface in an aqueous medium. Further, an anionic component can be used as the dispersant for an inorganic particle, such as an alumina hydrate, which has a positive surface electric charge. The inorganic particle can also be dispersed by physically adsorbing the dispersant on the surface of the inorganic particle. The dispersant can effectively suppress aggregation of the inorganic particle by an electrical repulsive power generated between molecules or a steric hindrance of molecules, and thus is suitable. The dispersant can be appropriately selected according to the properties of the inorganic particle, such as an acid, an alkali or a resin. The content (% by mass) of the dispersant in the ink can be 0.5% by mass or more to 15.0% by mass or less, or 1.0% by mass or more to 10.0% by mass or less with respect to the content (% by mass) of the inorganic particle. When the content of the dispersant is less than 0.5% by mass, the dispersion state of the inorganic particle is likely to be destabilized, and the inorganic particle is likely to be aggregated. Further, when the content of the dispersant is more than 15.0% by mass, the amount of the dispersant is excessive, which may lead to destabilization of the dispersion state of the inorganic particle, and as a result, the inorganic particle is likely to be aggregated.

### Resin Particle

The first resin contains the first resin particle. Since the first ink contains the first resin particle together with the inorganic particle, whereby the content of water can be reduced in accordance with the content of the first resin particle contained. Therefore, the image to be recorded is in a state where the inorganic particle is bound by the resin, and thus the strength of the image can be ensured. Further, when the first ink containing the first resin particle is used, the water absorption amount of the first image to be formed by drying at least a part of the liquid component of the first ink applied to the recording medium after the first ink applying step can be rapidly reduced. In this manner, the occurrence of image unevenness is likely to be suppressed. The resin particle is not required to be a hollow particle having a hole therein.

The term “resin particle” in the present specification denotes a resin present in a state of not being dissolved in an aqueous medium of an ink, and more specifically denotes a resin that can be present in an aqueous medium in the form of a particle having a particle diameter which can be measured by a dynamic light scattering method. In contrast, the term “water-soluble resin” denotes a resin present in a state of being dissolved in an aqueous medium of the ink. Whether or not a certain resin corresponds to “resin particle” can be determined by the following method. First, a liquid containing a resin as a determination target is prepared and diluted with pure water such that the content of the resin reaches about 1.0% to prepare a sample. Further, in a case where the particle diameter of the resin in the sample is measured by a dynamic light scattering method, the resin is determined to be “resin particle” (that is, “water-dispersible resin”) when a particle having a particle diameter is measured. Meanwhile, the resin is determined not to be “resin particle” (that is, “water-soluble resin”) when a particle having a particle diameter is not measured. Here, the measurement can be performed under conditions of, for example, a Set-Zero of 30 seconds, the number of times of measurement of 10 times, a measurement time of 120 seconds, a refractive index of 1.5 and a density of 1.0 in a true spherical shape. A particle size analyzer (for example, trade name “UPA-EX150”, manufactured by Nikkiso Co., Ltd.) or the like using a dynamic light scattering method can be used as a particle size distribution measuring device. Further, the particle size distribution measuring device to be used and the measurement conditions are not limited to those described above.

### Content

A content C_{R1} (% by mass) of the first resin particle in the first ink can be 2.5% by mass or more to 17.0% by mass or less, or 2.5% by mass or more to 14.0% by mass or less with respect to the total mass of the ink. Further, a content V_{R1} (% by volume) of the first resin particle in the first ink can be 2.5% by volume or more to 17.0% by volume or less, or 2.5% by volume or more to 14.0% by volume or less with respect to the total volume of the ink.

The volume ratio of the content V_{R1} (% by volume) of the first resin particle to the content V_{I} (% by volume) of the inorganic particle in the first ink can be 0.30 times or more to 5.00 times or less, or 0.40 times or more to 4.50 times or less. When the volume ratio thereof is more than 5.00 times, since the amount of the inorganic particle is relatively small, the number of gaps derived from the inorganic particle is also decreased, and the water absorption amount W₁ of the first image is decreased, the second ink is repelled by the first image, and thus the image unevenness cannot be sufficiently suppressed in some cases. Further, in a case where the hole is generated by heating the recording medium, since the refractive index of the binder is decreased, the concealing property of the first image is degraded. Therefore, the color developability of a color image recorded by applying the second ink onto the white image recorded with the first ink cannot be sufficiently obtained in some cases. Meanwhile, in a case where the volume ratio thereof is less than 0.30 times, deterioration, such as cracking, is likely to occur when the drying step and the second ink applying step are performed, and thus the color developability of the non-white image on the white background cannot be sufficiently obtained in some cases.

### Glass Transition Temperature and Melting Point

The first resin particle can be melted by setting the drying temperature T_{H} (° C.) in the drying step to be higher than or equal to the glass transition temperature Tg (° C.) or the melting point Tm (° C.) of the first resin particle. When the first resin particle is melted, the resin generated by the melting of the first resin particle permeates into the gap derived from the inorganic particle, and a hole roughly with a size corresponding to the size of the first resin particle is generated. Further, the inorganic particles are bound by the resin due to the permeation of the resin into the gap derived from the inorganic particle. Since these effects combine to increase the strength of the image, deterioration, such as cracking, is unlikely to occur even when the drying step and the second ink applying step are performed, and accordingly, the color developability of the non-white image on the white background can be further improved.

The first resin particle can maintain the shape of the particle without being melted before the drying step is performed. When the first resin particle is melted before the drying step is performed, the mixing of the inorganic particle and the first resin particle does not proceed rapidly, or the first resin particle is likely to be melted, and the inorganic particle and the first resin particle are unevenly distributed. Therefore, the first image cannot uniformly absorb the second ink, and as a result, the image unevenness cannot be sufficiently suppressed in some cases. The first resin particle can have a property of not being substantially melted at a normal temperature (25° C.) so that the first resin particle maintains the shape of the particle and is in a state of not being melted before the drying step is performed. Specifically, (i) the first resin particle can have a glass transition temperature Tg_{R} (° C.) of 25° C. or higher or (ii) the resin forming the first resin particle can be a crystalline resin and the first resin particle can have a melting point Tm_{R} (° C.) of 25° C. or higher. The expression “the melting point Tm_{R} (° C.) of the first resin particle is 25° C. or higher” is used when the condition (ii) is satisfied.

Both the glass transition temperature Tg (° C.) and the melting point Tm (° C.) of the first resin particle can be 100° C. or lower, or 80° C. or lower. The glass transition temperature Tg (° C.) and the melting point Tm (C) of the first resin particle can be measured with a differential scanning calorimeter (DSC).

Whether the resin forming the first resin particle is an amorphous resin or a crystalline resin can be determined by measuring the degree of crystallinity using a differential scanning calorimeter. A resin in which no melting peak is observed with a differential scanning calorimeter is determined to be an amorphous resin. Further, a resin in which a melting peak is observed is determined to be a crystalline resin. In a case where the resin is determined to be a crystalline resin, heat of fusion is determined from the peak area, and the degree of crystalline can also be determined from the ratio between the determined heat of fusion and heat of fusion of a perfect crystal substance in which the degree of crystallinity determined from theoretical calculation is 100%.

Whether or not the first resin particle is melted in the drying step can be easily determined by cutting the recording medium on which an image has been recorded before and after the drying step and observing the image with a scanning electron microscope or the like. Further, it can be determined that the first resin particle is melted and a hole is generated when the particle diameter of the first resin particle in the image before the drying step is measured and a difference between the size of the hole in the image and the particle diameter of the first resin particle after the drying step is small (for example, within 10%). It can be simply determined that the first resin particle is melted and a hole is generated when the spherical first resin particle disappears from the image after the drying step and a hole having almost the same size as the size of the first resin particle or a hole connecting particles is observed.

Specific examples of a method for confirming that the first resin particle is melted due to drying of the first image and the hole is generated in the drying step include the following method. First, the recording medium on which an image has been recorded is cut, and the image of the cut surface observed with a scanning electron microscope is captured. Thereafter, the captured image is binarized, and the area ratio of the black portion, which corresponds to the hole, to the entire image is calculated. When the area ratio of the hole to the image to be obtained by this method is 5% or more, it can be determined that the first resin particle is melted due to drying of the first image and the hole is generated. From the viewpoint of scattering efficiency, the area ratio thereof can be 10% or more, or 20% or more and 60% or less.

### Volume-Based Cumulative 50% Particle Diameter

The hole is generated when the first resin particle is melted, and the melted resin permeates into the gaps formed by a plurality of particles. The size of the hole to be formed greatly affects scattering of light. As the scattering efficiency increases, the color developability of the non-white image on the white background can be further improved. Therefore, from the viewpoint of further increasing the light scattering efficiency, the volume-based cumulative 50% particle diameter D50_{R1} (nm) of the first resin particle can be 80 nm or more to 400 nm or less, or 150 nm or more to 250 nm or less.

### Density

The density PR (g/cm³) of the first resin particle can be 1.00 g/cm³ or more to 2.00 g/cm³ or less, or 1.00 g/cm³ or more to 1.50 g/cm³ or less.

### Refractive Index

From the viewpoint of forming a binder having a high refractive index, the first resin particle having a relatively high refractive index can be used. The refractive index of the first resin particle can be 1.5 or more, or 1.6 or more and 2.5 or less.

### Acid Value and Weight-Average Molecular Weight

The acid value of the resin constituting the first resin particle can be 5 mgKOH/g or more to 100 mgKOH/g or less. The weight-average molecular weight of the resin constituting the first resin particle can be 1000 or more to 3000000 or less, or 100000 or more to 3000000 or less. The first resin particle is not required to contain a coloring material.

### Suitable Materials

Examples of the resin forming the first resin particle include an acrylic resin, a polyester-based resin, a urethane-based resin, a vinyl chloride-based resin and a styrene-based resin. Among these, from the viewpoint of ink jet properties, an acrylic resin, a polyester-based resin and a urethane-based resin can be used. When the first resin particle formed of a resin other than the resins described above is used, ejection is likely to be destabilized, and as a result, the image unevenness cannot be sufficiently suppressed in some cases. Among the examples, an acrylic resin can be used, and an acrylic resin having a unit derived from styrene can be suitably used. The details of the resin constituting the first resin particle will be described below. The acrylic resin may be a homopolymer formed of only one kind of monomer unit or a copolymer formed of a plurality of kinds of monomer units. The resin forming the first resin particle can be appropriately selected from the same resin compositions as described in the section of “other resins” below.

### Other Resins

The first ink may further contain resins (other resins) other than the first resin particle described above. The content (% by mass) of the resins (other resins) in the first ink can be 0.1% by mass or more to 20.0% by mass or less, or 0.5% by mass or more to 15.0% by mass or less with respect to the total mass of the ink.

The other resins can be added to the ink to stabilize the dispersion state of the pigment, that is, to serve as a resin dispersant or an assistant thereof. Further, the resin can be added to the ink to improve various properties of an image to be recorded. Examples of the form of the resin include a block copolymer, a random copolymer, a graft copolymer and a combination thereof. Further, the other resins may be water-soluble resins or resin particles. Among these, water-soluble resins can be used.

### Composition of Resin

Examples of the resin include an acrylic resin, a urethane-based resin, a polyester-based resin and an olefin-based resin. Among these, an acrylic resin or a urethane-based resin can be used, and an acrylic resin formed of a unit derived from (meth)acrylic acid or (meth)acrylate can be suitably used.

An acrylic resin having a hydrophilic unit and a hydrophobic unit as constituent units can be used as the acrylic resin. Among such examples, a resin having a hydrophilic unit derived from (meth)acrylic acid and a hydrophobic unit derived from at least one selected from the group consisting of a monomer having an aromatic ring and a (meth)acrylic acid ester-based monomer is suitable. Particularly, a resin having a hydrophilic unit derived from (meth)acrylic acid and a hydrophobic unit derived from at least one selected from the group consisting of styrene and α-methylstyrene is suitable. These resins are likely to interact with a pigment and thus can be suitably used as a resin dispersant for dispersing the pigment.

The hydrophilic unit is a unit containing a hydrophilic group such as an anionic group. The hydrophilic group can be formed by, for example, polymerizing a hydrophilic monomer containing a hydrophilic group. Specific examples of the hydrophilic monomer containing a hydrophilic group include an acidic monomer containing a carboxylic acid group such as (meth)acrylic acid, itaconic acid, maleic acid or fumaric acid, and an anionic monomer such as an anhydride or a salt of the acidic monomer. Examples of a cation constituting a salt of the acidic monomer include an ion such as lithium, sodium, sodium, potassium, ammonium or organic ammonium. The hydrophobic unit is a unit containing no hydrophilic group such as an anionic group. The hydrophobic unit can be formed by, for example, polymerizing a hydrophobic monomer containing no hydrophilic group such as an anionic group. Specific examples of the hydrophobic monomer include a monomer having an aromatic ring such as styrene, α-methylstyrene or benzyl (meth)acrylate and a (meth)acrylic acid ester-based monomer such as methyl (meth)acrylate, butyl (meth)acrylate and 2-ethylhexyl (meth)acrylate.

The urethane-based resin can be obtained by, for example, reacting a polyisocyanate with a polyol. Further, the urethane-based resin may be obtained by further reacting a chain extender. Examples of the olefin-based resin include polyethylene and polypropylene.

The polyester-based resin is typically formed of a unit derived from a polyhydric alcohol and a unit derived from a polycarboxylic acid. Examples of the polyhydric alcohol that forms a unit derived from a polyhydric alcohol, which constitutes a polyester-based resin through a reaction, include a dihydric to tetrahydric polyhydric alcohol. Examples of the polyhydric alcohol include polyhydric alcohols containing an aliphatic group, polyhydric alcohols containing an aromatic group and sugar alcohols.

Examples of the polyhydric alcohol include dihydric alcohols such as ethylene glycol (1,2-ethanediol), neopentyl (2,2-dimethyl-1,3-propanediol), 1,3-propanediol, 1,4-butanediol, benzenediol and 2,2-bis(4-hydroxyphenyl)propane (bisphenol A), trihydric alcohols such as glycerin, trimethylolethane and trimethylolpropane, and tetrahydric alcohols such as pentaerythritol. Further, an oligomer (low-molecular-weight polymer having a molecular weight of 1000 or less) can also be used as the polyhydric alcohol. From the viewpoint of easily adjusting the weight-average molecular weight of the polyester resin, dihydric or trihydric polyhydric alcohols can be used.

Examples of the polycarboxylic acid that forms a unit derived from a polycarboxylic acid, which constitutes a polyester-based resin through a reaction, include divalent to tetravalent polycarboxylic acids. Examples of the structure of the polycarboxylic acid include polycarboxylic acids containing an aliphatic group, polycarboxylic acids containing an aromatic group and nitrogen-containing polycarboxylic acids. Examples of the polycarboxylic acid include divalent carboxylic acids such as glutaric acid, adipic acid, terephthalic acid, isophthalic acid and 2,6-naphthalenedicarboxylic acid, trivalent carboxylic acids such as trimellitic acid, and tetravalent carboxylic acids such as ethylenediaminetetraacetic acid. Further, an oligomer (low-molecular-weight polymer having a molecular weight of 1000 or less) can also be used as the polycarboxylic acid. From the viewpoint of easily adjusting the weight-average molecular weight and the acid value of the polyester resin, divalent or trivalent polycarboxylic acids can be used.

### Physical Properties of Other Resins

The acid value of the water-soluble resin can be 100 mgKOH/g or more to 250 mgKOH/g or less. The weight-average molecular weight of the water-soluble resin can be 3000 or more to 15000 or less. Further, the acid value of the resin constituting the resin particle can be 5 mgKOH/g or more to 100 mgKOH/g or less. The weight-average molecular weight of the resin constituting the resin particle can be 100000 or more to 3000000 or less. The resin particle is not required to contain a coloring material.

### Aqueous Medium

The first ink is an aqueous ink containing at least water as an aqueous medium. The ink can contain water or an aqueous medium which is a mixed solvent of water and a water-soluble organic solvent. Deionized water or ion exchange water can be used as water. The content (% by mass) of water in the first ink can be 50.0% by mass or more to 95.0% by mass or less with respect to the total mass of the ink. Further, the content (% by mass) of the water-soluble organic solvent in the first ink can be 3.0% by mass or more to 50.0% by mass or less with respect to the total mass of the ink. Any water-soluble organic solvent that can be used for an ink jet ink, such as alcohols, (poly)alkylene glycols, glycol ethers, nitrogen-containing solvents or sulfur-containing solvents can be used as the water-soluble organic solvent.

The water-soluble organic solvent can have a boiling point of 250° C. or lower, or 230° C. or lower. The water-soluble organic solvent having a boiling point of 250° C. or lower is likely to be rapidly evaporated by the drying step. Meanwhile, since the water-soluble organic solvent having a boiling point of higher than 250° C. is likely to remain in the first image, and the water absorption amount W₁ of the first image is likely to be decreased, the drying step may take a long time.

### Other Components

The first ink may further contain a water-soluble organic compound in a solid state at 25° C., such as urea or a derivative thereof, trimethylolpropane or trimethylolethane. The content (% by mass) of the water-soluble organic compound in a solid state at 25° C. in the first ink can be 0.1% by mass or more to 10.0% by mass or less with respect to the total mass of the ink. Further, the first ink may contain various other components in addition the above-described components as necessary. Examples of the other components include various additives such as a wax particle, a surfactant, a defoaming agent, a pH adjuster, a viscosity adjuster, a rust inhibitor, a preservative, a fungicide, an antioxidant and a reducing inhibitor. Here, the first ink suitably contains no reactant used for the above-described reaction liquid.

### Physical Properties of Ink

The first ink is an aqueous ink to be applied to the ink jet type. Therefore, the physical properties thereof can be appropriately controlled from the viewpoint of the reliability. Specifically, the surface tension of the ink at 25° C. can be 20 mN/m or more to 60 mN/m or less. Further, the viscosity of the ink at 25° C. can be 1.0 mPa·s or more to 10.0 mPa·s or less. The pH of the ink at 25° C. can be 5.0 or more to 9.5 or less, or 6.0 or more to 9.0 or less.

### Water Absorption Amount W₁ of First Image

The water absorption amount W₁ (mL/m²) of the first image to be formed by drying at least a part of the liquid component of the first ink applied to the recording medium is required to be increased to 1.0 mL/m² or more until the second ink is applied. In a case where the water absorption amount W₁ of the first image is less than 1.0 mL/m² at the timing when the second ink is applied, the liquid component of the second ink cannot be absorbed by the first image, the pigment moves, and thus the image unevenness occurs. The water absorption amount W₁ of the first image at the timing when the second ink is applied can be 2.0 mL/m² or more to 30.0 mL/m² or less. The water absorption amount W₁ of the first image at the timing when the second ink is applied can be set to 1.0 mL/m² or more mainly by two methods. The volume of the gap derived from the inorganic particle may be increased when the application amount of the first ink is constant, and the application amount of the first ink may be increased when the composition of the first ink is constant. In a case where the volume of the gap derived from the inorganic particle is increased, the strength of the first image is decreased, deterioration, such as cracking, is likely to occur when the drying step and the second ink applying step are performed, and thus the color developability of the non-white image on the white background cannot be sufficiently obtained in some cases. Further, in a case where the application amount of the first ink is increased, since the liquid component of the first ink is unlikely to be dried, the drying step may take a long time to reduce the water absorption amount W₁ of the first image.

The water absorption amount W₁ (mL/m²) of the first image from the start of contact to 30 msec^{1/2} in the Bristow method can be measured by the Bristow method in the same manner as that for the water absorption amount of the recording medium. The value of the water absorption amount W₁ (mL/m²) of the first image at the timing when the second ink is applied and the tendency of a change in the value can be understood by changing the conditions of the drying step after the first ink is applied to the recording medium and measuring the water absorption amount W₁. Thereafter, the timing of applying the second ink when the recording apparatus is operated to record an image can be determined.

### Application Amount of First Ink

An application amount A₁ (mL/m²) of the first ink may be appropriately set according to image data, but can be set to 1 mL/m² or more to 50 mL/m² or less, or 10 mL/m² or more to 45 mL/m² or less. Further, the application amount A₁ (mL/m²) of the first ink can be more than an application amount A₂ (mL/m²) of the second ink.

### Second Ink

The second ink used for the recording method of the present disclosure contains a pigment and is an aqueous ink of a color different from the color of the first ink which is a white ink. The color of the second ink may be a color other than white, and any of various colors such as black, cyan, magenta, yellow and particular colors (such as red, green and blue) can be employed. Hereinafter, the components and the like constituting the ink will be described in detail.

### Pigment

The second ink contains a pigment as a coloring material. When the coloring material is a dye, since the ink in which the dye is dissolved permeates into the gaps formed by a plurality of inorganic particles in the first image, image unevenness occurs. When the coloring material is a pigment, permeation of the coloring material into the first image is effectively suppressed, and accordingly, the pigment can be present on the first image. The content (% by mass) of the pigment in the second ink can be 0.5% by mass or more to 15.0% by mass or less, or 1.0% by mass or more to 10.0% by mass or less with respect to the total mass of the second ink.

Specific examples of the pigment include an inorganic particle such as carbon black or a metal oxide, and an organic pigment such as azo, phthalocyanine, quinacridone, isoindolinone, imidazolone, diketopyrrolopyrrole or dioxazine.

As a pigment dispersion method, a resin-dispersed pigment formed of a resin as a dispersant or a self-dispersible pigment in which a hydrophilic group is bonded to the particle surface of the pigment can be used. Further, for example, a resin-bonded pigment in which an organic group containing a resin is chemically bonded to the particle surface of the pigment or a microcapsule pigment in which the particle surface of the pigment is coated with a resin can be used. Among these, pigments using different dispersion methods can also be used in combination. Among these, a self-dispersible pigment in which a hydrophilic group is bonded to the particle surface of the pigment or a resin-dispersed pigment in which a resin as a dispersant is physically adsorbed on the particle surface of the pigment can be used.

A resin dispersant that can disperse the pigment in an aqueous medium using the action of an anionic group can be used as the resin dispersant for dispersing the pigment in an aqueous medium. Resins containing an anionic group can be used as the resin dispersant, and the following resins and particularly water-soluble resins among the resins can be used. The content (% by mass) of the pigment in the second ink can be 0.3 times or more to 10.0 times or less in terms of the mass ratio with respect to the content (% by mass) of the resin dispersant.

As the self-dispersible pigment, a pigment in which an anionic group such as a carboxylic acid group, a sulfonic acid group or a phosphonic acid group is bonded to the particle surface of the pigment directly or via another atomic group (—R—) can be used. The anionic group may be of an acid type or a salt type and may be in a dissociable state partially or entirely in a case where the anionic group is of a salt type. Examples of the cation serving as a counter ion include an alkali metal cation, aluminum and organic aluminum in the case where the anionic group is of a salt type. Specific examples of the other atomic groups (—R—) include a linear or branched alkylene group having 1 to 12 carbon atoms, an arylene group such as a phenylene group or a naphthylene group, a carbonyl group, an imino group, an amide group, a sulfonyl group, an ester group and an ether group. Further, a group obtained by combining these groups may be used.

The volume-based cumulative 50% particle diameter D50_{P} (nm) of the pigment can be 20 nm or more to 300 nm or less, or 60 nm or more to 200 nm or less. When the volume-based cumulative 50% particle diameter D50_{P} (nm) of the pigment is less than 20 nm, the pigment of the second ink enters the gap derived from the inorganic particle in the first image recorded with the first ink, and thus the color developability of the non-white image on the white background cannot be sufficiently obtained in some cases. Further, when the volume-based cumulative 50% particle diameter D50_{P} (nm) of the pigment is more than 300 nm, the size of the pigment particle is extremely large, the color development efficiency is low, and thus the color developability of the non-white image on the white background cannot be sufficiently obtained in some cases. The volume-based cumulative 50% particle diameter D50_{P} (nm) of the pigment can be measured with a particle size analyzer (for example, trade name “UPA-EX150”, manufactured by Nikkiso Co., Ltd.) or the like using a dynamic light scattering method. Further, the particle size distribution measuring device to be used, the measurement conditions and the like are not limited to those described above.

### Resin

The second ink contains a resin. An image with improved abrasion resistance can be recorded by using an ink containing a resin. The resin can be added to the ink to stabilize the dispersion state of the pigment, that is, to serve as a resin dispersant or an assistant thereof. Further, the resin can be added to the ink to improve various properties of an image to be recorded. Examples of the form of the resin include a block copolymer, a random copolymer, a graft copolymer and a combination thereof. Further, the resin may be any of a water-soluble resin or a resin particle.

The content (% by mass) of the resin in the second ink can be 0.1% by mass or more to 20.0% by mass or less, or 0.5% by mass or more to 15.0% by mass or less with respect to the total mass of the second ink.

The second ink can contain the resin particle (second resin particle). Since the ink containing the second resin particle can increase the content of the resin while suppressing an increase in viscosity of the ink, the content of the liquid component in the second ink can be decreased. In this manner, since the viscosity of the second ink can be rapidly increased when the second ink is applied onto the first image, the image unevenness can be more effectively suppressed, and the color developability of the non-white image on the white background can be further improved.

The resin forming the second resin particle can be appropriately selected from resins having the same compositions as those described above in the section of “other resins” used in the first ink. Among these, an acrylic resin and a urethane-based resin can be used.

### Aqueous Medium

The second ink is an aqueous ink containing at least water as an aqueous medium. The ink can contain water or an aqueous medium which is a mixed solvent of water and a water-soluble organic solvent. Deionized water or ion exchange water can be used as water. The content (% by mass) of water in the second ink can be 50.0% by mass or more to 95.0% by mass or less with respect to the total mass of the ink. Further, the content (% by mass) of the water-soluble organic solvent in the second ink can be 3.0% by mass or more to 50.0% by mass or less with respect to the total mass of the ink. Any water-soluble organic solvent that can be used for an ink jet ink, such as alcohols, (poly)alkylene glycols, glycol ethers, nitrogen-containing solvents, or sulfur-containing solvents can be used as the water-soluble organic solvent.

The water-soluble organic solvent can have a boiling point of 250° C. or lower, or 230° C. or lower. The water-soluble organic solvent having a boiling point of 250° C. or lower is likely to be rapidly evaporated by the drying step. In contrast, since the water-soluble organic solvent having a boiling point of higher than 250° C. remains in the image and inhibits light scattering, the concealing property is likely to be degraded, and thus the color developability of the non-white image on the white background cannot be sufficiently obtained in some cases.

### Other Components

The second ink may further contain a water-soluble organic compound in a solid state at 25° C., such as urea or a derivative thereof, trimethylolpropane or trimethylolethane. The content of the water-soluble organic compound in a solid state at 25° C. in the second ink can be 0.1% by mass or more to 10.0% by mass or less with respect to the total mass of the ink. Further, the second ink may contain various other components in addition the above-described components as necessary. Examples of the other components include various additives such as a wax particle, a surfactant, a defoaming agent, a pH adjuster, a viscosity adjuster, a rust inhibitor, a preservative, a fungicide, an antioxidant and a reducing inhibitor. Here, the second ink suitably contains no reactant used for the above-described reaction liquid.

### Physical Properties of Ink

The second ink is an aqueous ink to be applied to the ink jet type. Therefore, the physical properties thereof can be appropriately controlled from the viewpoint of the reliability. Specifically, the surface tension of the ink at 25° C. can be 20 mN/m or more to 60 mN/m or less. Further, the viscosity of the ink at 25° C. can be 1.0 mPa·s or more to 10.0 mPa·s or less. The pH of the ink at 25° C. can be 5.0 or more to 9.5 or less, or 6.0 or more to 9.0 or less.

### Application Amount of Second Ink

The ratio of the application amount A₂ (mL/m²) of the second ink to the water absorption amount W₁ (mL/m²) of the first image can be 20.0 times or less, or 15.0 times or less. When the ratio thereof is more than 20.0 times, since the first image cannot sufficiently absorb the liquid component of the second ink, the pigment of the second ink is likely to move on the first image, and as a result, the image unevenness is likely to occur in some cases. The ratio of the application amount A₂ (mL/m²) of the second ink to the water absorption amount W₁ (mL/m²) of the first image can be 0.1 times or more, or 1.0 times of more. The application amount A₂ (mL/m²) of the second ink may be appropriately set according to the image data, but can be set to 1 mL/m² or more to 50 mL/m² or less, or 1 mL/m² or more to 20 mL/m² or less.

### Reaction Liquid

The recording method of the present disclosure may include a first reaction liquid applying step of applying an aqueous reaction liquid containing a reactant that reacts with the first ink to the recording medium or a second reaction liquid applying step of applying an aqueous reaction liquid containing a reactant that reacts with the second ink to the recording medium. Here, the reaction liquid applying step can be performed before the ink applying step, or the ink applying step and the reaction liquid applying step can be performed at the same time. More preferably, the method includes both the first reaction liquid applying step and the second reaction liquid applying step. In the present specification, the reaction liquid used with the first ink is also referred to as the first reaction liquid, and the reaction liquid used with the second ink is also referred to as the second reaction liquid, but the reaction liquid common to both the reaction liquids is simply referred to as “reaction liquid”.

The components such as the inorganic particle, the first resin particle and the like of the first ink are aggregated by applying the first reaction liquid to overlap the region where the first ink is applied. When the inorganic particle is aggregated, since the pore volume of the aggregate is added, the water absorption amount W₁ of the first image can be further increased, and accordingly, the image unevenness can be more effectively suppressed. The ratio of the application amounts can be changed by considering the reactivity between the first ink and the first reaction liquid so that the water absorption amount W₁ of the first image is controlled to a desired value.

Further, the components such as the pigment and the like of the second ink are aggregated by applying the second reaction liquid to overlap the region where the second ink is applied. When the pigment is aggregated, the ink is thickened, solid-liquid separation occurs between the liquid component of the ink and the aggregate, the pigment of the second ink can be efficiently fixed onto the first image, and the image unevenness can be more effectively suppressed.

The first reaction liquid and the second reaction liquid may have compositions different from each other according to the properties of the first ink and the second ink, or may be the reaction liquid common to the first ink and the second ink. Hereinafter, each component and the like used in the reaction liquid will be described in detail.

### Reactant

The reaction liquid aggregates components (components containing an anionic group such as a resin) in the ink by reacting with the ink when coming into contact with the ink and contains a reactant. Due to the presence of the reactant, the state of presence of the components containing an anionic group in the ink is destabilized when the ink and the reactant come into contact with each other in the recording medium, and thus the aggregation of the ink can be promoted. Examples of the reactant include an organic acid, a polyvalent metal salt and a cationic resin.

Examples of the polyvalent metal ion constituting the polyvalent metal salt include divalent metal ions such as Ca²⁺, Cu²⁺, Ni²⁺, Mg²⁺, Sr²⁺, Ba²⁺ and Zn²⁺, and trivalent metal ions such as Fe²⁺, Cr²⁺, Y²⁺, and A²⁺. In order to allow the reaction liquid to contain the polyvalent metal ion, a water-soluble polyvalent metal salt (may be a hydrate) formed by bonding a polyvalent metal ion and an anion to each other can be used. Examples of the anion constituting the polyvalent metal salt include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻, and organic anions such as HCOO⁻, (COO⁻)₂, COOH(COO⁻), CH₃COO⁻, C₂H₅COO—, CH₃CH(OH)COO⁻, C₂H₄(COO⁻)₂, C₆H₄COO⁻, C₆H₄(COO⁻)₂ and CH₃SO₃⁻. In a case where the polyvalent metal ion is used as the reactant, the content (% by mass) thereof in terms of the polyvalent metal salt in the reaction liquid can be 1.0% by mass or more to 40.0% by mass or less with respect to the total mass of the reaction liquid. In the present specification, “content (% by mass) of the polyvalent metal salt” in the reaction liquid in a case where the polyvalent metal salt is a hydrate denotes “content (% by mass) of an anhydride of the polyvalent metal salt” excluding water as a hydrate.

The reaction liquid containing an organic acid has a buffer capacity in an acidic region (pH of less than 7.0 and suitably 2.0 to 5.0) and thus efficiently aggregates anionic groups of the components present in the ink in the form of an acid. Examples of the organic acid include a monocarboxylic acid such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid or coumaric acid and a salt thereof, a dicarboxylic acid such as oxalic acid, malonic acid, succinic acid, glutaric acid, adipic acid, maleic acid, fumaric acid, itaconic acid, sebacic acid, phthalic acid, malic acid or tartaric acid, a salt thereof and a hydrogen salt thereof, a tricarboxylic acid such as citric acid or trimellitic acid, a salt thereof and a hydrogen salt thereof, and a tetracarboxylic acid such as pyromellitic acid, a salt thereof and a hydrogen salt thereof. When an organic acid is used as the reactant, the content (% by mass) of the organic acid in the reaction liquid can be 1.0% by mass or more to 50.0% by mass or less with respect to the total mass of the reaction liquid.

Examples of the cationic resin include a resin having a structure of primary to tertiary amines and a resin having a structure of a quaternary ammonium salt. Specific examples thereof include a resin having a structure of vinylamine, allylamine, vinylimidazole, vinylpyridine, dimethylaminoethyl methacrylate, ethyleneimine, guanidine, diallyldimethylammonium chloride or an alkylamine/epichlorohydrin condensate. In order to increase the solubility in the reaction liquid, the cationic resin and an acidic compound can be used in combination or the cationic resin can be subjected to a quaternization treatment. When the cationic resin is used as the reactant, the content (% by mass) of the cationic resin in the reaction liquid can be 0.1% by mass or more to 10.0% by mass or less with respect to the total mass of the reaction liquid.

### Aqueous Medium

The reaction liquid is an aqueous reaction liquid containing at least water as an aqueous medium. The aqueous medium used in the reaction liquid can contain the above-described water-soluble organic solvent that can be contained in the ink. In particular, the water-soluble organic solvent used in the first reaction liquid can have a boiling point of 250° C. or lower, or 230° C. or lower. The water-soluble organic solvent having a boiling point of 250° C. or lower is likely to be rapidly evaporated by the drying step, and thus the color developability can be further improved. Since the water-soluble organic solvent having a boiling point of higher than 250° C. is likely to remain in the first image, the drying step may take a long time in order to decrease the water absorption amount W₁ of the first ink.

### Other Components

The reaction liquid may contain various other components as necessary. Examples of the other components include the above-described other components that can be contained in the ink.

### Physical Properties of Reaction Liquid

The reaction liquid is an aqueous reaction liquid to be applied to the ink jet type. Therefore, the physical property values thereof can be appropriately controlled from the viewpoint of the reliability. Specifically, the surface tension of the reaction liquid at 25° C. can be 20 mN/m or more to 60 mN/m or less. Further, the viscosity of the reaction liquid at 25° C. can be 1.0 mPa·s or more to 10.0 mPa·s or less. The pH of the reaction liquid at 25° C. can be 5.0 or more to 9.5 or less, or 6.0 or more to 9.0 or less.

### EXAMPLES

Hereinafter, the present disclosure will be described in more detail with reference to examples and comparative examples. The present disclosure is not limited to the following examples unless the gist thereof is overstepped. In regard to the component amount, “parts” and “%” are on a mass basis unless otherwise specified.

### Measurement of Physical Property Values

### Density

The densities of the inorganic particle and the resin particle were measured by a Gay-Lussac type specific gravity bottle (pycnometer) method in conformity with JIS Z 8807.

### Total Pore Volume

An aqueous dispersion liquid of the particle was dried and solidified at 60° C. to obtain a powder of the particle. About 0.10 g of the obtained particle was placed in a cell with an inner diameter of ⅜ inch, and the particle was dried by deaeration until the pressure reached 20 millitorr or less while the cell was heated to 60° C. using a sample pretreatment device (trade name “VacPrep 061”, manufactured by Micromeritics Instrument Corporation), thereby obtaining a sample. The pore volume distribution of the particle (inorganic particle) of the obtained sample was measured by a nitrogen adsorption and desorption method using a using a Micromeritics automatic specific surface area/pore distribution measuring device (trade name, “TRISTAR II” manufactured by Shimadzu Corporation). The measured value on the nitrogen desorption side from the measured pore volume distribution was defined as the total pore volume.

### Volume-Based Cumulative 50% Particle Diameter

The volume-based cumulative 50% particle diameters D50_{P} and D50_{R} of the inorganic particle and the resin particle were measured with a particle diameter measuring device (trade name “UPA-EX150”, manufactured by Nikkiso Co., Ltd.) using a dynamic light scattering method.

### Glass Transition Temperature and Melting Point

The glass transition temperature Tg and the melting point Tm of the resin particle were measured using a differential scanning calorimeter (DSC). 2 mg of the resin particle obtained by drying and solidifying the aqueous dispersion liquid of the resin particle at 60° C. was placed in an aluminum container, and the container was sealed to prepare a sample for measurement. The prepared sample was subjected to thermal analysis according to the following temperature programs using a differential scanning calorimeter (trade name “DSC-2500”, manufactured by TA Instruments). The glass transition temperature of the resin particle in the present specification is defined as follows. That is, in a temperature rise curve (horizontal axis: temperature, vertical axis: heat quantity) of the following temperature program (4) or (5), the temperature at an intersection between a straight line extending to a high temperature side through two points on a low temperature side curve and a tangent drawn at a point where the gradient of a step-wise change portion on the curve is maximized. The temperature determined as described above was defined as “glass transition temperature of the resin particle”. Further, the melting point of the resin particle was measured in the same manner as in the following temperature programs (1) to (4) except that the upper limit of the temperature in the program (4) was changed, and the peak top of the endothermic peak of the temperature rise curve was defined as “melting point Tm of the particle”.

### Temperature Programs

(1) Temperature rise from −40° C. to 200° C. at 10° C./min
(2) Temperature maintained at 200° C. for 5 minutes
(3) Temperature drop from 200° C. to −40° C. at 10° C./min
(4) Temperature rise from −40° C. to 200° C. at 10° C./min
(5) Temperature rise from −40° C. to 150° C. at 10° C./min

### Preparation of Inorganic Particle

The following inorganic particles were prepared. A mixing stirrer (trade name, “TK ROBOMIX”, manufactured by PRIMIX Corporation) was used as a disperser. The properties of the inorganic particles are listed in Table 1.

### Inorganic Particle 1

200.5 parts of ion exchange water, 4.5 parts of 2,2′,2″-nitrilotriethanol and 95.0 parts of the inorganic particle of the type listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.05 mm were placed in the disperser and dispersed at 2700 rpm for 5 hours. Thereafter, an appropriate amount of ion exchange water was added thereto, thereby obtaining an aqueous dispersion liquid of the inorganic particle 1 in which the content of the particle was 30.0%.

### Inorganic Particle 2

224.3 parts of ion exchange water, 12.7 parts of an acrylic resin aqueous solution (trade name “BYK-154”, manufactured by BYK-Chemie GmbH, content of resin: 42.0%) and 63.0 parts of the inorganic particle of the type listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.05 mm were placed in the disperser and dispersed at 2000 rpm for 5 hours. Thereafter, an appropriate amount of ion exchange water was added thereto, thereby obtaining an aqueous dispersion liquid of the inorganic particle 2 in which the content of the particle was 20.0%.

### Particle 3

222.7 parts of ion exchange water, 1.2 parts of acetic acid, 13.1 parts of an acrylic resin aqueous solution (trade name “ARON A-210”, manufactured by Toagosei Co., Ltd., content of resin: 43.0 g) and 63.0 parts of the inorganic particle of the type listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.05 mm were placed in the disperser and dispersed at 1360 rpm for 1 hour. Thereafter, an appropriate amount of ion exchange water was added thereto, thereby obtaining a dispersion liquid of the inorganic particle 3 in which the content of the particle was 20.0%.

### Inorganic Particle 4

185.0 parts of ion exchange water, 20.0 parts of an acrylic resin aqueous solution (trade name “BYK-190”, manufactured by BYK-Chemie GmbH, content of resin: 40.0%) and 95.0 parts of the inorganic particle of the type listed in Table 1 were mixed with each other. The mixture was dispersed at 750 rpm for 30 minutes using the above-described disperser. Thereafter, an appropriate amount of ion exchange water was added thereto, thereby obtaining a dispersion liquid of the inorganic particle 4 in which the content of the particle was 30.0%.

### Inorganic Particle 5

200.5 parts of ion exchange water, 4.5 parts of 2,2′,2″-nitrilotriethanol and 95.0 parts of the inorganic particle of the type listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.05 mm were placed in the disperser and dispersed at 2700 rpm for 5 hours. Thereafter, an appropriate amount of ion exchange water was added thereto, thereby obtaining a dispersion liquid of the inorganic particle 5 in which the content of the particle was 30.0%.

### Inorganic Particle 6

200.5 parts of ion exchange water, 4.5 parts of 2,2′,2″-nitrilotriethanol and 95.0 parts of the inorganic particle of the type listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 150.0 mL (bulk volume) of beads having a diameter of 0.05 mm were placed in the disperser and dispersed at 1350 rpm for 5 hours. Thereafter, an appropriate amount of ion exchange water was added thereto, thereby obtaining a dispersion liquid of the inorganic particle 6 in which the content of the particle was 30.0%.

### Inorganic Particle 7

200.5 parts of ion exchange water, 4.5 parts of 2,2′,2″-nitrilotriethanol and 95.0 parts of the inorganic particle of the type listed in Table 1 were mixed with each other. The mixture was pre-dispersed at 750 rpm for 30 minutes using the above-described disperser, thereby obtaining a pre-dispersion liquid. Next, 150.0 mL of the pre-dispersion liquid obtained above and 225.0 mL (bulk volume) of beads having a diameter of 0.05 mm were placed in the disperser and dispersed at 2700 rpm for 5 hours. Thereafter, an appropriate amount of ion exchange water was added thereto, thereby obtaining a dispersion liquid of the inorganic particle 7 in which the content of the particle was 30.0%.

### Inorganic Particle 8

200.5 parts of ion exchange water, 4.5 parts of 2,2′,2″-nitrilotriethanol and 95.0 parts of the inorganic particle of the type listed in Table 1 were mixed with each other. The mixture was dispersed at 750 rpm for 30 minutes using the above-described disperser. Thereafter, an appropriate amount of ion exchange water was added thereto, thereby obtaining a dispersion liquid of the inorganic particle 8 in which the content of the particle was 30.0%.

TABLE 1
Properties of inorganic particle

| | | | Content of | Density | Total pore |
|---|---|---|---|---|---|
| Particle | Trade name | Material | particle (%) | ρ_{I} (g/cm³) | volume (mL/g) |
| 1 | Titanium oxide fine particle | Titanium | 30.0 | 4.2 | 0.24 |
| | (trade name “MT-100WP”, | oxide | | | |
| | manufactured by Tayca | | | | |
| | Corporation) | | | | |
| 2 | Light calcium carbonate | Calcium | 20.0 | 2.7 | 0.26 |
| | (trade name “VISCAL”, | carbonate | | | |
| | manufactured by NEW | | | | |
| | LIME CO., LTD.) | | | | |
| 3 | Fumed alumina | Aluminum | 20.0 | 3.4 | 0.23 |
| | (trade name “AEROXIDE | oxide | | | |
| | Alu C”, manufactured by | | | | |
| | Nippon Aerosil Co., Ltd.) | | | | |
| 4 | Titanium oxide ultrafine | Titanium | 30.0 | 4.2 | 0.28 |
| | particle | oxide | | | |
| | (trade name “TTO-51(A)”, | | | | |
| | manufactured by Tayca | | | | |
| | Corporation) | | | | |
| 5 | Titanium oxide | Titanium | 30.0 | 4.2 | 0.20 |
| | (trade name “JR-403”, | oxide | | | |
| | manufactured by Tayca | | | | |
| | Corporation) | | | | |
| 6 | Titanium oxide | Titanium | 30.0 | 4.2 | 0.03 |
| | (trade name “JR-403”, | oxide | | | |
| | manufactured by Tayca | | | | |
| | Corporation) | | | | |
| 7 | Titanium oxide | Titanium | 30.0 | 4.2 | 0.10 |
| | (trade name “JR-403”, | oxide | | | |
| | manufactured by Tayca | | | | |
| | Corporation) | | | | |
| 8 | Titanium oxide | Titanium | 30.0 | 4.2 | 0.02 |
| | (trade name “JR-403”, | oxide | | | |
| | manufactured by Tayca | | | | |
| | Corporation) | | | | |

### Preparation of Resin Particle

The following resin particles were prepared. The properties of the resin particles are listed in Table 2.

### Resin Particles 1 to 3 and 6 to 9

0.2 parts of potassium persulfate and 74.0 parts of ion exchange water were mixed with each other to prepare a solution. Further, the monomer (unit: parts) listed in Table 1 and 0.3 parts of a reactive surfactant were mixed with each other to prepare an emulsified product. As the abbreviations of the monomers, St represents styrene, 2EHA represents 2-ethylhexyl acrylate, MMA represents methyl methacrylate and AA represents acrylic acid. A nonionic surfactant (trade name “ADEKA REASOAP ER-20”, manufactured by Adeka Corporation, number of ethylene oxide units: 20) was used as the reactive surfactant. The emulsified product was added dropwise to the solution over 1 hour in a nitrogen atmosphere, and the solution was polymerized for 3 hours while being stirred at 80° C. and further stirred for 2 hours. The solution was cooled to 25° C., ion exchange water and a potassium hydroxide aqueous solution were added to the solution to adjust the pH thereof to 8.0, and an appropriate amount of ion exchange water was added thereto to adjust the solid content, thereby obtaining an aqueous dispersion liquid of each resin particle.

### Resin Particle 4

An aqueous dispersion liquid (trade name “SUPERFLEX 300”, manufactured by DKS Co., Ltd.) of a polyurethane resin particle was used as an aqueous dispersion liquid of the resin particle 4.

### Resin Particle 5

A mixture of 498 parts of terephthalic acid, 498 parts of isophthalic acid, 876 parts of adipic acid, and 2280 parts of bisphenol A was added to a reaction container placed in an autoclave and heated at 250° C. and 13 kPa for 6 hours to carry out an esterification reaction. Next, 0.8 parts of antimony trioxide and 0.15 parts of phosphoric acid were added thereto as catalysts, the mixture was heated to 270° C., and the pressure inside the reaction container was gradually reduced to 13 Pa over 1.5 hours. The polycondensation reaction was continued for 4 hours in a state of maintaining the temperature at 270° C. and the reduced pressure at 13 Pa, and the pressure was returned to the normal pressure by introducing nitrogen gas into the reaction container. The temperature was decreased to 265° C., 15 parts of trimellitic acid was added to the mixture, and the mixture was heated at 265° C. for 2 hours to carry out a polymerization reaction, thereby obtaining a polyester resin 1.

A stirrer (trade name “Tornado Standard SM-101”, manufactured by AS ONE Corporation) was set in a 2 L beaker. 150 parts of the polyester resin 1 obtained above and 350 parts of tetrahydrofuran were added to the beaker, and the mixture was stirred at 25° C. to dissolve the resin. Next, a 5% sodium hydroxide aqueous solution was added thereto such that the neutralization rate of the acid group of the resin reached 100%, and the solution was stirred for 30 minutes, thereby obtaining a slurry. 700 parts of deionized water was added dropwise to the beaker at a rate of 20 mL/min while the solution was stirred at 25° C. and 150 rpm. After the solution was heated to 60° C., tetrahydrofuran was distilled off under reduced pressure, and some water was also distilled off. Next, the beaker was placed in a water bath at 85° C., and the contents were stirred for 2 hours and subjected to a heat treatment. The contents were filtered through a 150 mesh wire net, and an appropriate amount of ion exchange water was added thereto, thereby obtaining an aqueous dispersion liquid of the first resin particle 5 in which the content of the resin was 30.0%.

TABLE 2
Properties of resin particle

| | | | | | Properties | | | | |
|---|---|---|---|---|---|---|---|---|---|
| | | | | | Content of | | | | |
| Resin | Monomer (unit: parts) | | | | resin particle | D50_{R1} | Tg_{R1} | Tm_{R1} | ρ_{R1} |
| particle | St | 2EHA | MMA | AA | (%) | (nm) | (° C.) | (° C.) | (g/cm³) |
| 1 | 13.0 | 1.5 | 10.0 | 1.0 | 30.0 | 200 | 80 | — | 1.2 |
| 2 | 12.0 | 2.5 | 10.0 | 1.0 | 30.0 | 200 | 70 | — | 1.2 |
| 3 | 3.3 | 1.7 | 20.0 | 1.0 | 30.0 | 200 | 80 | — | 1.2 |
| 4 | — | — | — | — | 30.0 | 70 | −−42 | — | 1.0 |
| 5 | — | — | — | — | 30.0 | 150 | — | 80 | 1.3 |
| 6 | 13.0 | 1.5 | 10.0 | 1.0 | 30.0 | 70 | 80 | — | 1.2 |
| 7 | 13.0 | 1.5 | 10.0 | 1.0 | 30.0 | 80 | 80 | — | 1.2 |
| 8 | 13.0 | 1.5 | 10.0 | 1.0 | 30.0 | 400 | 80 | — | 1.2 |
| 9 | 13.0 | 1.5 | 10.0 | 1.0 | 30.0 | 450 | 80 | — | 1.2 |

### Preparation of Pigment Dispersion Liquid

Each pigment dispersion liquid was prepared by the following procedures. The content of the pigment, the content of the resin and the volume-based cumulative 50% particle diameter D50_{P} of the pigment in the obtained pigment dispersion liquid are listed in Table 3.

### Pigment Dispersion Liquid 1

1.5 parts of 4-amino-1,2-benzenedicarboxylic acid was added to a solution obtained by dissolving 5 parts of concentrated hydrochloric acid in 5.5 parts of water in a state where the solution was cooled to 5° C. Next, the solution was constantly maintained at a temperature of 10° C. or lower by placing the container containing the solution in an ice bath, and a solution obtained by dissolving 1.8 parts of sodium nitrite in 9 parts of water at 5° C. was added thereto. The resulting solution was further stirred for 15 minutes, and 6.0 parts of carbon black (trade name “NIPex 160 IQ”, manufactured by Orion Engineered Carbons S.A.) having a DBP oil absorption of 128 mL/100 g was added to the solution while the solution was stirred. Thereafter, the solution was further stirred for 15 minutes, the obtained slurry was filtered through filter paper (trade name “Standard Filter Paper No. 2”, manufactured by Advantec), and the particle was sufficiently washed with water. The particle was dried in an oven at 110° C. to prepare a self-dispersible pigment. Further, an appropriate amount of ion exchange water was added to the obtained self-dispersible pigment to disperse the pigment such that the content of the pigment reached 10.0%, thereby preparing a dispersion liquid. Thereafter, the counter ion of the anionic group was substituted with a potassium ion from a sodium ion using an ion exchange method, thereby obtaining a pigment dispersion liquid 1.

### Pigment Dispersion Liquid 2

An acrylic resin (trade name “JONCRYL 683”, manufactured by BASF SE) was added to sodium hydroxide in an amount equimolar to the acid value, and the mixture was dissolved in ion exchange water to prepare an aqueous solution of a resin dispersant in which the content of the resin was 20.0%. A mixture of 10.0 parts of a pigment, 25.0 parts of an aqueous solution of the resin dispersant, and 65.0 parts of water was placed in a sand grinder, and subjected to a dispersion treatment for 1 hour. Carbon black (trade name “NIPex 160 IQ”, manufactured by Orion Engineered Carbons S.A.) having a DBP oil absorption of 128 mL/100 g was used as the pigment. Thereafter, the mixture was subjected to a centrifugation treatment and pressurized and filtered through a cellulose acetate filter (manufactured by Advantec) having a pore size of 3.0 μm, and an appropriate amount of ion exchange water was added thereto, thereby obtaining a pigment dispersion liquid 2. The content of the resin in the pigment dispersion liquid 2 was 5.0%.

### Pigment Dispersion Liquid 3

7.0 parts of a pigment (C.I. Pigment Blue 15:3), 14.0 mmol of a ((4-aminobenzoylamino)-methane-1,1-diyl)bisphosphonic acid monosodium salt, 40.0 mmol of nitric acid and 200.0 parts of pure water were mixed with each other. Next, the mixture was mixed using a Silverson mixer at 25° C. and 6000 rpm. After 30 minutes, 40.0 mmol of sodium nitrite dissolved in a small amount of ion exchange water was slowly added to the mixture. The temperature of the mixture reached 60° C. due to the addition of sodium nitrite, and the mixture was allowed to react in this state for 1 hour. Thereafter, a sodium hydroxide aqueous solution was added to the mixture to adjust the pH thereof to 10. 20.0 parts of ion exchange water was added thereto, and the mixture was diafiltered through a spectrum membrane. Next, an appropriate amount of ion exchange water was added thereto, thereby obtaining a pigment dispersion liquid 3.

### Pigment Dispersion Liquid 4

7.0 parts of a pigment (C.I. Pigment Red 122), 14.0 mmol of a ((4-aminobenzoylamino)-methane-1,1-diyl)bisphosphonic acid monosodium salt, 40.0 mmol of nitric acid and 200.0 parts of ion exchange water were mixed with each other. Next, the mixture was mixed using a Silverson mixer at 25° C. and 6000 rpm. After 30 minutes, 40.0 mmol of sodium nitrite dissolved in a small amount of ion exchange water was slowly added to the mixture. The temperature of the mixture reached 60° C. due to the addition of sodium nitrite, and the mixture was allowed to react in this state for 1 hour. Thereafter, a sodium hydroxide aqueous solution was added to the mixture to adjust the pH thereof to 10. 20.0 parts of ion exchange water was added thereto, and the mixture was diafiltered through a spectrum membrane. Next, an appropriate amount of ion exchange water was added thereto, thereby obtaining a pigment dispersion liquid 4.

### Pigment Dispersion Liquids 5 and 6

The type of the pigment was changed to carbon black (trade name “BLACK PEARLS 880”, manufactured by Cabot Corporation) having a DBP oil absorption amount of 105 mL/100 g. Further, the volume-based cumulative 50% particle diameter D50_{P} of the pigment was adjusted by changing the conditions for stirring the mixture. Pigment dispersion liquids 5 and 6 were obtained by the same procedures as those for the pigment dispersion liquid 1 except for the changes described above.

### Pigment Dispersion Liquid 7

The type of the pigment was changed to carbon black (trade name “MONARCH 700”, manufactured by Cabot Corporation) having a DBP oil absorption amount of 122 mL/100 g. Further, the volume-based cumulative 50% particle diameter D50_{P} of the pigment was adjusted by changing the conditions for stirring the mixture. A pigment dispersion liquid 7 was obtained by the same procedures as those for the pigment dispersion liquid 1 except for the changes described above.

### Pigment Dispersion Liquid 8

The type of the pigment was changed to carbon black (trade name “TOKABLACK #5500”, manufactured by TOKAI CARBON CO., LTD.) having a DBP oil absorption amount of 155 mL/100 g. Further, the volume-based cumulative 50% particle diameter D50_{P} of the pigment was adjusted by changing the conditions for stirring the mixture. A pigment dispersion liquid 8 was obtained by the same procedures as those for the pigment dispersion liquid 1 except for the changes described above.

TABLE 3
Conditions for preparing pigment dispersion
liquid and properties thereof

| Pigment dispersion | | Content of | D50_{Pig} |
|---|---|---|---|
| liquid | Type of pigment | pigment (%) | (nm) |
| 1 | Carbon black | 10.0 | 150 |
| 2 | Carbon black | 10.0 | 155 |
| 3 | C.I. Pigment Blue 15:3 | 10.0 | 172 |
| 4 | C.I. Pigment Red 122 | 10.0 | 167 |
| 5 | Carbon black | 10.0 | 57 |
| 6 | Carbon black | 10.0 | 60 |
| 7 | Carbon black | 10.0 | 200 |
| 8 | Carbon black | 10.0 | 300 |

### Preparation of First Ink

The components (unit: %) listed in the upper columns of Tables 4 and 5 were mixed, potassium hydroxide (included in the amount of ion exchange water used) was added thereto, and the pH of the ink was adjusted to be in a range of 7 to 9. The mixture was pressurized and filtered through a microfilter (manufactured by FUJIFILM Corporation) having a pore size of 3.0 μm to prepare each ink. In Tables 4 and 5, “SURFYNOL 465” is the trade name of a nonionic surfactant (acetylene glycol ethylene oxide adduct, manufactured by Nissin Chemical Industry Co., Ltd.). The properties of each ink are listed in the lower columns of Tables 4 and 5.

TABLE 4
Composition and properties of first ink

| | First ink | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Aqueous dispersion liquid of inorganic particle 1 | 50.0 | 50.0 | 50.0 | 50.0 | 50.0 | | | | | | | 50.0 | 50.0 |
| Aqueous dispersion liquid of inorganic particle 2 | | | | | | 48.6 | | | | | | | |
| Aqueous dispersion liquid of inorganic particle 3 | | | | | | | 50.0 | | | | | | |
| Aqueous dispersion liquid of inorganic particle 4 | | | | | | | | | | 50.0 | | | |
| Aqueous dispersion liquid of inorganic particle 5 | | | | | | | | | 50.0 | | | | |
| Aqueous dispersion liquid of inorganic particle 6 | | | | | | | | 50.0 | | | | | |
| Aqueous dispersion liquid of inorganic particle 7 | | | | | | | | | | | 50.0 | | |
| Aqueous dispersion liquid of inorganic particle 8 | | | | | | | | | | | | | |
| Aqueous dispersion liquid of resin particle 1 | 27.7 | | | | | 27.7 | 27.7 | 27.7 | 27.7 | 27.7 | 27.7 | | |
| Aqueous dispersion liquid of resin particle 2 | | 27.7 | | | | | | | | | | | |
| Aqueous dispersion liquid of resin particle 3 | | | 27.7 | | | | | | | | | | |
| Aqueous dispersion liquid of resin particle 4 | | | | 27.7 | | | | | | | | | |
| Aqueous dispersion liquid of resin particle 5 | | | | | 27.7 | | | | | | | | |
| Aqueous dispersion liquid of resin particle 6 | | | | | | | | | | | | 27.7 | |
| Aqueous dispersion liquid of resin particle 7 | | | | | | | | | | | | | 27.7 |
| Aqueous dispersion liquid of resin particle 8 | | | | | | | | | | | | | |
| Aqueous dispersion liquid of resin particle 9 | | | | | | | | | | | | | |
| 1,2-Butanediol | 20.0 | 20.0 | 20.0 | 20.0 | 20.0 | 20.0 | 20.0 | 20.0 | 20.0 | 20.0 | 20.0 | 20.0 | 20.0 |
| SURFYNOL 465 | 0.5 | 0.5 | 0.5 | 0.5 | 0.5 | 0.5 | 0.5 | 0.5 | 0.5 | 0.5 | 0.5 | 0.5 | 0.5 |
| Ion exchange water | 1.8 | 1.8 | 1.8 | 1.8 | 1.8 | 3.2 | 1.8 | 1.8 | 1.8 | 1.8 | 1.8 | 1.8 | 1.8 |
| Content C_{I} of inorganic particle (% by mass) | 15.0 | 15.0 | 15.0 | 15.0 | 15.0 | 9.7 | 10.0 | 15.0 | 15.0 | 15.0 | 15.0 | 15.0 | 15.0 |
| Content C_{R1} of resin particle (% by mass) | 8.3 | 8.3 | 8.3 | 8.3 | 8.3 | 8.3 | 8.3 | 8.3 | 8.3 | 8.3 | 8.3 | 8.3 | 8.3 |
| Content V_{I} of inorganic particle (% by volume) | 3.6 | 3.6 | 3.6 | 3.6 | 3.6 | 3.6 | 2.9 | 3.6 | 3.6 | 3.6 | 3.6 | 3.6 | 3.6 |
| Content V_{R1} of resin particle (% by volume) | 6.9 | 6.9 | 6.9 | 9.7 | 6.4 | 6.9 | 6.9 | 6.9 | 6.9 | 6.9 | 6.9 | 6.9 | 6.9 |
| Value of V_{R1}/V_{I} (times) | 1.9 | 1.9 | 1.9 | 2.7 | 1.8 | 1.9 | 2.4 | 1.9 | 1.9 | 1.9 | 1.9 | 1.9 | 1.9 |

TABLE 5
Composition and properties of first ink

| | First ink | | | | | | | | | | | | |
|---|---|---|---|---|---|---|---|---|---|---|---|---|---|
| | 14 | 15 | 16 | 17 | 18 | 19 | 20 | 21 | 22 | 23 | 24 | 25 | 26 |
| Aqueous dispersion liquid of inorganic particle 1 | 50.0 | 50.0 | 50.0 | 50.0 | 32.0 | 32.0 | 15.0 | | 50.0 | 50.0 | | 33.3 | |
| Aqueous dispersion liquid of inorganic particle 2 | | | | | | | | | | | | | |
| Aqueous dispersion liquid of inorganic particle 3 | | | | | | | | | | | | | |
| Aqueous dispersion liquid of inorganic particle 4 | | | | | | | | | | | | | 50.0 |
| Aqueous dispersion liquid of inorganic particle 5 | | | | | | | | | | | | | |
| Aqueous dispersion liquid of inorganic particle 6 | | | | | | | | | | | | | |
| Aqueous dispersion liquid of inorganic particle 7 | | | | | | | | | | | 40.0 | | |
| Aqueous dispersion liquid of inorganic particle 8 | | | | | | | | 50.0 | | | | | |
| Aqueous dispersion liquid of resin particle 1 | | | 3.0 | 3.5 | 46.5 | 47.0 | | 12.5 | | | 27.7 | 13.3 | |
| Aqueous dispersion liquid of resin particle 2 | | | | | | | | | | | | | 20.0 |
| Aqueous dispersion liquid of resin particle 3 | | | | | | | | | | | | | |
| Aqueous dispersion liquid of resin particle 4 | | | | | | | | | | | | | |
| Aqueous dispersion liquid of resin particle 5 | | | | | | | | | | | | | |
| Aqueous dispersion liquid of resin particle 6 | | | | | | | 20.0 | | | | | | |
| Aqueous dispersion liquid of resin particle 7 | | | | | | | | | | | | | |
| Aqueous dispersion liquid of resin particle 8 | 27.7 | | | | | | | | | | | | |
| Aqueous dispersion liquid of resin particle 9 | | 27.7 | | | | | | | | | | | |
| 1,2-Butanediol | 20.0 | 20.0 | 20.0 | 20.0 | 20.0 | 20.0 | 20.0 | 20.0 | 20.0 | 20.0 | 20.0 | 13.0 | 20.0 |
| SURFYNOL 465 | 0.5 | 0.5 | 0.5 | 0.5 | 0.5 | 0.5 | 0.5 | 0.5 | 0.5 | 0.5 | 0.5 | 1.0 | 0.5 |
| Ion exchange water | 1.8 | 1.8 | 26.5 | 26.0 | 1.0 | 0.5 | 44.5 | 17.0 | 29.5 | 29.5 | 11.8 | 39.4 | 9.5 |
| Content C_{I} of inorganic particle (% by mass) | 15.0 | 15.0 | 15.0 | 15.0 | 9.6 | 9.6 | 4.5 | 15.0 | 15.0 | 15.0 | 12.0 | 10.0 | 15.0 |
| Content C_{R1} of resin particle (% by mass) | 8.3 | 8.3 | 0.9 | 1.1 | 14.0 | 14.1 | 6.0 | 3.8 | 0.0 | 0.0 | 8.3 | 4.0 | 6.0 |
| Content V_{I} of inorganic particle (% by volume) | 3.6 | 3.6 | 3.6 | 3.6 | 2.3 | 2.3 | 1.1 | 3.6 | 3.6 | 3.6 | 2.9 | 2.4 | 3.6 |
| Content V_{R1} of resin particle (% by volume) | 6.9 | 6.9 | 0.8 | 0.9 | 11.6 | 11.8 | 5.0 | 3.1 | 0.0 | 0.0 | 6.9 | 3.3 | 5.0 |
| Value of V_{R1}/V_{I} (times) | 1.9 | 1.9 | 0.2 | 0.3 | 5.0 | 5.1 | 4.5 | 0.9 | 0.0 | 0.0 | 2.4 | 1.4 | 1.4 |

### Preparation of Second Ink

The components (unit: %) listed in Table 6 were mixed, potassium hydroxide (included in the amount of ion exchange water used) was added thereto, and the pH of the ink was adjusted to be in a range of 8 to 9. The mixture was pressurized and filtered through a microfilter (manufactured by FUJIFILM Corporation) having a pore size of 3.0 μm to prepare each ink. In Table 6, “SURFYNOL 465” is the trade name of a nonionic surfactant (acetylene glycol ethylene oxide adduct, manufactured by Nissin Chemical Industry Co., Ltd.).

TABLE 6
Composition of second ink

| | Second ink | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| Pigment dispersion liquid 1 | 40.0 | | | | | | | | 40.0 | 40.0 | | | 40.0 | 30.0 |
| Pigment dispersion liquid 2 | | 40.0 | | | | | | | | | | | | |
| Pigment dispersion liquid 3 | | | 40.0 | | | | | | | | | | | |
| Pigment dispersion liquid 4 | | | | 40.0 | | | | | | | | | | |
| Pigment dispersion liquid 5 | | | | | 40.0 | | | | | | 40.0 | | | |
| Pigment dispersion liquid 6 | | | | | | 40.0 | | | | | | | | |
| Pigment dispersion liquid 7 | | | | | | | 40.0 | | | | | | | |
| Pigment dispersion liquid 8 | | | | | | | | 40.0 | | | | | | |
| C.I. Direct Blue 199 | | | | | | | | | | | | 3.0 | | |
| Aqueous dispersion liquid of resin particle 4 | | | | | | | | | | 30.0 | | | | |
| Aqueous dispersion liquid of resin particle 7 | 30.0 | 30.0 | 30.0 | 30.0 | 30.0 | 30.0 | 30.0 | 30.0 | | | | 30.0 | 6.7 | 17.0 |
| 1,2-Butanediol | 15.0 | 15.0 | 15.0 | 15.0 | 15.0 | 15.0 | 15.0 | 15.0 | 15.0 | 15.0 | 15.0 | 15.0 | 18.0 | 15.0 |
| SURFYNOL 465 | 0.5 | 0.5 | 0.5 | 0.5 | 0.5 | 0.5 | 0.5 | 0.5 | 0.5 | 0.5 | 0.5 | 0.5 | 1.0 | 0.5 |
| Ion exchange water | 14.5 | 14.5 | 14.5 | 14.5 | 14.5 | 14.5 | 14.5 | 14.5 | 44.5 | 14.5 | 44.5 | 51.5 | 34.3 | 37.5 |

### Preparation of Reaction Liquid

### Reaction Liquid 1

7.0 parts of a magnesium sulfate heptahydrate, 20.0 parts of 1,2-butanediol, 0.5 parts of a nonionic surfactant (trade name, “SURFYNOL 465”, manufactured by Nissin Chemical Industry Co., Ltd.) and 72.5 parts of ion exchange water were mixed with each other and sufficiently stirred. Thereafter, the mixture was pressurized and filtered through a cellulose acetate filter (manufactured by Advantec) having a pore size of 3.0 μm, thereby preparing a reaction liquid 1.

### Reaction Liquid 2

5.0 parts of a magnesium sulfate heptahydrate, 37.0 parts of a liquid containing a cationic resin, 20.0 parts of 1,2-butanediol, 0.5 parts of a nonionic surfactant (trade name, “SURFYNOL 465”, manufactured by Nissin Chemical Industry Co., Ltd.) and 37.5 parts of ion exchange water were mixed with each other and sufficiently stirred. As the liquid containing a cationic resin, “UNISENSE FPA100L” (trade name, manufactured by SENKA Corporation, content of cationic resin: 27.0%) was used. Thereafter, the mixture was pressurized and filtered through a cellulose acetate filter (manufactured by Advantec) having a pore size of 3.0 μm, thereby preparing a reaction liquid 2.

### Preparation of Recording Medium

The following recording media were prepared.
Recording medium 1: polyethylene terephthalate film (trade name “Ultra-transparent PET film GIY-0305”, manufactured by LINTEC Corporation, water absorption amount Wₘ from start of contact to 30 msec^{1/2} is 10.0 mL/m² or less in Bristow method)
Recording medium 2: highly transparent vinyl chloride (trade name “3M Scotchcal Clear Graphic Film IJ8150”, manufactured by 3M Company, water absorption amount Wₘ from start of contact to 30 msec^{1/2} is 10.0 mL/m² or less in Bristow method)
Recording medium 3: black coated paper (trade name “FSPG Color B”, manufactured by Daio Paper Corporation, water absorption amount Wₘ from start of contact to 30 msec^{1/2} is 10.0 mL/m² or less in Bristow method)
Recording medium 4: high quality paper (trade name “Colored Fine Paper Black Thick”, manufactured by TAKEO CO., LTD., water absorption amount Wₘ from start of contact to 30 msec^{1/2} is 10.0 mL/m² or less in Bristow method)

### Evaluation

The following items were evaluated using the reaction liquids and the inks obtained above. In the present disclosure, “AA”, “A” and “B” were determined to be acceptable levels, and “C” was determined to be an unacceptable level in the evaluation criteria for each item described below. The evaluation results are listed in Table 7.

### Recording of Image for Evaluation

The reaction liquid and the ink listed in Table 7 were used as a set to record an image for evaluation (solid image) under the following conditions. In the present example, the recording duty of the solid image recorded under the condition of applying 2 liquid droplets (the reaction liquid or the ink) with a mass of 4.0 ng per droplet to a unit area of 1/1200 inch×1/1200 inch was defined as 100%. The reaction liquid and the ink were applied in this order to the recording medium listed in Table 7 using the recording apparatus listed in Table 7 such that the reaction liquid and the ink overlapped each other, to record a solid image with a size of 50 mm×50 mm. Here, the application amount of each reaction liquid was set to 20% (on a volume basis) with respect to the application amount of the ink, and the application amount of each ink was set to the value listed in Table 7. In Comparative Examples 3, 5 and 7 and Reference Example 2, the second ink was applied without drying the first image by stopping a first drying unit 2100.
Recording apparatus 1: A cartridge filled with the first reaction liquid was set in the first reaction liquid applying device 1102 of the ink jet recording apparatus having the configuration shown in FIG. 3, and a cartridge filled with the first ink was set in the first ink applying device 1103. Further, a cartridge filled with the second reaction liquid was set in the second reaction liquid applying device 1202, and a cartridge filled with the second ink was set in the second ink applying device 1203. The reaction liquids and the inks were applied to the unit area by a single-pass method of performing relative scanning once on the recording head and the recording medium. The recording medium was air-dried by the first drying unit 2000 such that the surface temperature thereof reached the drying temperature listed in Table 7 after the first reaction liquid and the first ink were applied to the recording medium, thereby forming a first image. Thereafter, the recording medium was air-dried by the second drying unit 2300 such that the surface temperature thereof reached 80° C. after the second reaction liquid and the second ink were applied to the first image, and the surface of the recording medium was heated at this drying temperature.
Recording apparatus 2: Cartridges respectively filled with the first reaction liquid, the second reaction liquid, the first ink and the second ink were set in the ink jet recording apparatus having the configuration shown in FIG. 4. The reaction liquids and the inks were applied to the unit area by a multi-pass method of performing relative scanning a plurality of times on the recording head and the recording medium, and the scanning for applying the first ink and the scanning for applying the second ink were performed differently. The recording medium was air-dried by the drying device provided on a downstream side of the recording head in the conveyance direction of the recording medium such that the surface temperature of the recording medium reached the drying temperature listed in Table 7 after the first reaction liquid and the first ink were applied to the recording medium, thereby forming a first image. Thereafter, the second reaction liquid and the second ink were applied onto the first image, and the recording medium was heated by the heater 25 such that the surface temperature thereof reached 80° C.

### Measurement of Water Absorption Amount W₁ of First Image

After the application of the first reaction liquid and the first ink to the recording medium under the above-described conditions, air-drying was carried out under the conditions listed in Table 7, thereby forming the first image. Thereafter, the recording medium was discharged from the recording apparatus without performing the application of the second reaction liquid and the second ink. The water absorption amount W₁ (mL/m²) of the first image immediately after the discharge of the recording medium from the start of contact to 30 msec^{1/2} in the Bristow method was measured using a dynamic permeability testing device (trade name “Dynamic Permeability Tester”, manufactured by Toyo Seiki Seisaku-sho, Ltd.) using the Bristow method.

### Image Unevenness

In a case where release paper was present on the rear surface of the recording medium, the release paper was removed, and an image overlapped a white polyethylene terephthalate film (trade name “LUMIRROR #250-E20”, manufactured by Toray Industries, Inc.) with the recording surface of the recorded image facing up. The image was read from the recording surface side using a scanner (trade name “DR-C225II”, manufactured by Canon Inc.), the solid image was subjected to binarization processing, and the area ratio (%) of the site (dark portion of the image) recorded according to input data was calculated. The reading conditions were for a color image at a resolution of 600 dpi. The binarization processing was performed by converting the image to 8-bit using image processing software “ImageJ” and setting the threshold value for the gradation value (Gtop) at the peak of the brightness histogram at white 255/black 0 to [(255+Gtop)/2]. The ratio (area ratio) of the area with the threshold value or more obtained above was calculated, and the image unevenness was evaluated according to the following evaluation criteria. In the present example, a case where the area ratio was 80% or more was determined to be “image unevenness did not occur”.
AA: The area ratio was 95.0% or more.
A: The area ratio was 90.0% or more to less than 95.0%.
B: The area ratio was 80.0% or more to less than 90.0%.
C: The area ratio was less than 80.0%, and image unevenness occurred.

### Color Developability

In a case where release paper was present on the rear surface of the recording medium, the release paper was removed, and an image overlapped a white polyethylene terephthalate film (trade name “LUMIRROR #100-T60”, manufactured by Toray Industries, Inc.) with the recording surface of the recorded image facing up. The brightness (L*) and the chroma saturation (C*) of the solid image in the CIELab color specification system were measured from the recording surface side using a fluorescence spectrodensitometer (trade name “FD-7”, manufactured by KONICA MINOLTA, INC.). Further, the color developability was measured according to the following evaluation criteria. The degree to which an ink is perceived as being dark varies depending on the hue of the ink, and thus the evaluation criteria for the color developability were set according to the hue of the ink in the present example. In a case of a black ink containing carbon black as a pigment, the image becomes darker as the brightness decreases, and this indicates that the color developability is satisfactory. Further, in a case of chromatic color inks containing an organic pigment as the pigment (a cyan ink containing C.I. Pigment Blue 15:3 and a magenta ink containing C.I. Pigment Red 122), the image becomes more vivid as the chroma saturation increases, and this indicates that the color developability is satisfactory.

### Evaluation Criteria for Black Ink

AA: The brightness L* was 9 or less.
A: The brightness L* was more than 9 to 10 or less.
B: The brightness L′ was more than 10 to 11 or less.
C: The brightness L′ was more than 11.

### Evaluation Criteria for Cyan Ink

AA: The chroma saturation C* was 65 or more.
A: The chroma saturation C* was 60 or more to less than 65.
B: The chroma saturation C* was 55 or more to less than 60.
C: The chroma saturation C* was less than 55.

### Evaluation Criteria for Magenta Ink

AA: The chroma saturation C* was 75 or more.
A: The chroma saturation C* was 70 or more to less than 75.
B: The chroma saturation C* was 65 or more to less than 70.
C: The chroma saturation C* was less than 65.

TABLE 7
Evaluation conditions and evaluation results

| | | Evaluation conditions | | | | | | | |
|---|---|---|---|---|---|---|---|---|---|
| | | | | | | | | | Water |
| | | | | | | | | Application | absorption |
| | | First | | Second | | | | amount A₁ | amount W₁ |
| | | reaction | First | reaction | Second | Recording | Recording | of first ink | of first image |
| | | liquid | ink | liquid | ink | apparatus | medium | (mL/m²) | (mL/m²) |
| Example | 1 | 1 | 1 | 1 | 1 | 1 | 1 | 30 | 4.5 |
| | 2 | 1 | 1 | 1 | 1 | 1 | 2 | 30 | 4.5 |
| | 3 | 1 | 1 | 1 | 1 | 1 | 3 | 30 | 4.5 |
| | 4 | 1 | 1 | 1 | 2 | 1 | 1 | 30 | 4.5 |
| | 5 | 1 | 1 | 1 | 3 | 1 | 1 | 30 | 4.5 |
| | 6 | 1 | 1 | 1 | 4 | 1 | 1 | 30 | 4.5 |
| | 7 | 1 | 2 | 1 | 1 | 1 | 1 | 30 | 4.5 |
| | 8 | 1 | 3 | 1 | 1 | 1 | 1 | 30 | 4.5 |
| | 9 | 1 | 4 | 1 | 1 | 1 | 1 | 30 | 4.5 |
| | 10 | 1 | 5 | 1 | 1 | 1 | 1 | 30 | 4.5 |
| | 11 | 1 | 6 | 1 | 1 | 1 | 1 | 43 | 4.5 |
| | 12 | 1 | 7 | 1 | 1 | 1 | 1 | 46 | 4.5 |
| | 13 | 1 | 8 | 1 | 1 | 1 | 1 | 30 | 1.1 |
| | 14 | 1 | 9 | 1 | 1 | 1 | 1 | 30 | 4.0 |
| | 15 | 1 | 10 | 1 | 1 | 1 | 1 | 30 | 5.2 |
| | 16 | 1 | 11 | 1 | 1 | 1 | 1 | 20 | 1.0 |
| | 17 | 1 | 1 | 1 | 1 | 1 | 1 | 30 | 4.5 |
| | 18 | 1 | 1 | 1 | 1 | 2 | 1 | 30 | 3.0 |
| | 19 | 1 | 1 | 1 | 1 | 1 | 1 | 12 | 1.9 |
| | 20 | 1 | 1 | 1 | 1 | 1 | 1 | 13 | 2.0 |
| | 21 | 1 | 1 | 1 | 1 | 1 | 1 | 13 | 5.0 |
| | 22 | 1 | 1 | 1 | 1 | 1 | 1 | 13 | 2.0 |
| | 23 | 1 | 1 | 1 | 1 | 1 | 1 | 13 | 2.0 |
| | 24 | 1 | 1 | 1 | 1 | 1 | 1 | 13 | 2.0 |
| | 25 | 1 | 1 | 1 | 1 | 1 | 1 | 13 | 2.0 |
| | 26 | 1 | 12 | 1 | 1 | 1 | 1 | 30 | 4.5 |
| | 27 | 1 | 13 | 1 | 1 | 1 | 1 | 30 | 4.5 |
| | 28 | 1 | 14 | 1 | 1 | 1 | 1 | 30 | 4.5 |
| | 29 | 1 | 15 | 1 | 1 | 1 | 1 | 30 | 4.5 |
| | 30 | 1 | 1 | 1 | 5 | 1 | 1 | 30 | 4.5 |
| | 31 | 1 | 1 | 1 | 6 | 1 | 1 | 30 | 4.5 |
| | 32 | 1 | 1 | 1 | 7 | 1 | 1 | 30 | 4.5 |
| | 33 | 1 | 1 | 1 | 8 | 1 | 1 | 30 | 4.5 |
| | 34 | 1 | 16 | 1 | 1 | 1 | 1 | 30 | 4.5 |
| | 35 | 1 | 17 | 1 | 1 | 1 | 1 | 30 | 4.5 |
| | 36 | 1 | 18 | 1 | 1 | 1 | 1 | 30 | 3.5 |
| | 37 | 1 | 19 | 1 | 1 | 1 | 1 | 30 | 3.1 |
| | 38 | 1 | 1 | 1 | 9 | 1 | 1 | 30 | 3.0 |
| | 39 | 1 | 1 | 1 | 10 | 1 | 1 | 30 | 4.5 |
| | 40 | 2 | 1 | 1 | 1 | 1 | 1 | 30 | 4.5 |
| | 41 | — | 1 | 1 | 1 | 1 | 1 | 30 | 2.0 |
| | 42 | 1 | 1 | — | 1 | 1 | 1 | 30 | 4.5 |
| | 43 | — | 1 | — | 1 | 1 | 1 | 30 | 2.0 |
| | 44 | — | 20 | — | 11 | 1 | 1 | 25 | 1.9 |
| Comparative | 1 | 1 | 21 | 1 | 1 | 1 | 1 | 30 | 0.5 |
| Example | 2 | 1 | 22 | 1 | 1 | 1 | 1 | 30 | 4.5 |
| | 3 | 1 | 23 | 1 | 1 | 1 | 1 | 30 | 4.0 |
| | 4 | 1 | 1 | 1 | 12 | 1 | 1 | 30 | 4.5 |
| | 5 | 1 | 1 | 1 | 1 | 1 | 1 | 30 | 4.5 |
| | 6 | 1 | 24 | 1 | 1 | 1 | 1 | 20 | 0.9 |
| | 7 | 1 | 25 | — | 13 | 2 | 1 | 20 | 0.4 |
| | 8 | — | 26 | 2 | 14 | 2 | 1 | 13.4 | 0.4 |
| Reference | 1 | 1 | 1 | 1 | 1 | 1 | 4 | 30 | 4.5 |
| Example | 2 | 1 | 1 | 1 | 1 | 1 | 1 | 30 | 4.5 |

| | | Evaluation conditions | | | | |
|---|---|---|---|---|---|---|
| | | Application | Temperature | | | |
| | | amount A₂ | T_{H} in drying | Value of | Evaluation results | |
| | | of second ink | step | A₂/W₁ | Image | Color |
| | | (mL/m²) | (° C.) | (times) | unevenness | developability |
| Example | 1 | 18 | 90 | 4.0 | AA | AA |
| | 2 | 18 | 90 | 4.0 | AA | AA |
| | 3 | 18 | 90 | 4.0 | AA | AA |
| | 4 | 18 | 90 | 4.0 | AA | AA |
| | 5 | 18 | 90 | 4.0 | AA | AA |
| | 6 | 18 | 90 | 4.0 | AA | AA |
| | 7 | 18 | 90 | 4.0 | AA | AA |
| | 8 | 18 | 90 | 4.0 | AA | AA |
| | 9 | 18 | 90 | 4.0 | AA | A |
| | 10 | 18 | 90 | 4.0 | AA | AA |
| | 11 | 18 | 90 | 4.0 | AA | AA |
| | 12 | 18 | 90 | 4.0 | AA | AA |
| | 13 | 14 | 90 | 12.7 | A | AA |
| | 14 | 18 | 90 | 4.5 | AA | AA |
| | 15 | 18 | 90 | 3.5 | AA | AA |
| | 16 | 10 | 90 | 10.0 | A | AA |
| | 17 | 18 | 70 | 4.0 | AA | A |
| | 18 | 18 | 70 | 6.0 | AA | A |
| | 19 | 18 | 90 | 9.5 | A | AA |
| | 20 | 18 | 90 | 9.0 | AA | AA |
| | 21 | 5 | 90 | 1.0 | AA | AA |
| | 22 | 40 | 90 | 20.0 | A | AA |
| | 23 | 42 | 90 | 21.0 | B | AA |
| | 24 | 30 | 90 | 15.0 | AA | AA |
| | 25 | 32 | 90 | 16.0 | A | AA |
| | 26 | 18 | 90 | 4.0 | AA | A |
| | 27 | 18 | 90 | 4.0 | AA | AA |
| | 28 | 18 | 90 | 4.0 | AA | AA |
| | 29 | 18 | 90 | 4.0 | AA | A |
| | 30 | 18 | 90 | 4.0 | AA | A |
| | 31 | 18 | 90 | 4.0 | AA | AA |
| | 32 | 18 | 90 | 4.0 | AA | AA |
| | 33 | 18 | 90 | 4.0 | AA | A |
| | 34 | 18 | 90 | 4.0 | AA | A |
| | 35 | 18 | 90 | 4.0 | AA | AA |
| | 36 | 18 | 90 | 5.1 | AA | AA |
| | 37 | 18 | 90 | 5.8 | B | A |
| | 38 | 18 | 90 | 6.0 | B | A |
| | 39 | 18 | 90 | 4.0 | AA | AA |
| | 40 | 18 | 90 | 4.0 | AA | AA |
| | 41 | 18 | 90 | 9.0 | A | AA |
| | 42 | 18 | 90 | 4.0 | AA | A |
| | 43 | 18 | 90 | 9.0 | A | A |
| | 44 | 40 | 70 | 21.1 | B | B |
| Comparative | 1 | 18 | 90 | 36.0 | C | B |
| Example | 2 | 18 | 90 | 4.0 | C | B |
| | 3 | 18 | — | 4.5 | C | B |
| | 4 | 18 | 90 | 4.0 | C | B |
| | 5 | 18 | — | 4.0 | C | B |
| | 6 | 10 | 90 | 11.1 | C | B |
| | 7 | 20 | — | 50.0 | C | B |
| | 8 | 16 | 90 | 40.0 | C | B |
| Reference | 1 | 18 | 90 | 4.0 | A | B |
| Example | 2 | 18 | — | 4.0 | A | B |

The present disclosure provides an ink jet recording method that suppresses occurrence of image unevenness in a case where a first ink which is a white ink and a second ink which is a non-white ink are applied in this order to a low to non-absorbing recording medium. Further, according to another embodiment, the present disclosure provides an ink jet recording apparatus used for the ink jet recording method.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-203723, filed Nov. 22, 2024 and No. 2025-182972, filed Oct. 29, 2025, which are hereby incorporated by reference herein in their entirety.

What is claimed is:

1. An ink jet recording method of ejecting a first ink and a second ink, which are aqueous inks, from an ink jet type recording head to record an image on a recording medium in which a water absorption amount Wₘ from a start of contact to 30 msec^{1/2} is 10.0 mL/m² or less in a Bristow method, the ink jet recording method comprising:
applying the first ink to the recording medium;
drying at least a part of a liquid component of the first ink applied to the recording medium to form a first image; and
applying the second ink to the first image to overlap at least a part of the first image to record the image,
wherein the first ink is a white ink comprising an inorganic particle and a first resin particle,
the inorganic particle has a total pore volume of 0.03 cm³/g or more, which is measured by a nitrogen adsorption and desorption method,
the second ink comprises a pigment and is an ink of a color different from the color of the first ink, and
the applying of the second ink is performed after a water absorption amount W₁ of the first image from the start of contact to 30 msec^{1/2} is set to 1.0 mL/m² or more in the Bristow method by the drying of at least a part of the liquid component.

2. The ink jet recording method according to claim 1,
wherein the drying of at least a part of the liquid component is performed at a temperature T_{H} higher than or equal to a glass transition temperature Tg or a melting point Tm of the first resin particle.

3. The ink jet recording method according to claim 1,
wherein the applying of the second ink is performed after the water absorption amount W₁ of the first image from the start of contact to 30 msec^{1/2} is set to 2.0 mL/m² or more in the Bristow method by the drying of at least a part of the liquid component.

4. The ink jet recording method according to claim 1,
wherein a ratio of an application amount A₂ of the second ink to the water absorption amount W₁ measured by the Bristow method is 20.0 times or less.

5. The ink jet recording method according to claim 1,
wherein a ratio of an application amount A₂ of the second ink to the water absorption amount W₁ measured by the Bristow method is 15.0 times or less.

6. The ink jet recording method according to claim 1,
wherein the first resin particle has a volume-based cumulative 50% particle diameter D50_{R1} of 80 nm or more to 400 nm or less.

7. The ink jet recording method according to claim 1,
wherein the pigment has a volume-based cumulative 50% particle diameter D50_{P} of 60 nm or more to 200 nm or less.

8. The ink jet recording method according to claim 1,
wherein a volume ratio of a content V_{R1} of the first resin particle to a content V_{I} of the inorganic particle in the first ink is 0.3 times or more to 5.0 times or less.

9. The ink jet recording method according to claim 1,
wherein the second ink further comprises a second resin particle.

10. The ink jet recording method according to claim 1,
wherein the inorganic particle comprises titanium oxide.

11. The ink jet recording method according to claim 1,
wherein the resin forming the first resin particle is at least one selected from the group consisting of an acrylic resin, a polyester-based resin and a urethane-based resin.

12. The ink jet recording method according to claim 9,
wherein the resin forming the second resin particle is at least one selected from the group consisting of an acrylic resin and a urethane-based resin.

13. The ink jet recording method according to claim 1, further comprising:
at least one step consisting of (1) applying an aqueous reaction liquid comprising a reactant that reacts with the first ink to the recording medium and (2) applying an aqueous reaction liquid comprising a reactant that reacts with the second ink to the recording medium.

14. The ink jet recording method according to claim 13,
wherein the ink jet recording method includes both the applying of an aqueous reaction liquid comprising a reactant that reacts with the first ink and the applying of an aqueous reaction liquid comprising a reactant that reacts with the second ink.

15. An ink jet recording apparatus that ejects a first ink and a second ink, which are aqueous inks, from an ink jet type recording head to record an image on a recording medium in which a water absorption amount Wₘ from a start of contact to 30 msec^{1/2} is 10.0 mL/m² or less in a Bristow method, the apparatus comprising:
a first ink applying means configured to apply the first ink to the recording medium;
a drying means configured to dry at least a part of a liquid component of the first ink applied to the recording medium to form a first image; and
a second ink applying means configured to apply the second ink to the first image to overlap at least a part of the first image to record the image,
wherein the first ink is a white ink comprising an inorganic particle and a first resin particle,
the inorganic particle has a total pore volume of 0.03 cm³/g or more, which is measured by a nitrogen adsorption and desorption method,
the second ink comprises a pigment and is an ink of a color different from the color of the first ink, and
the second ink applying means applies the second ink after a water absorption amount W₁ of the first image from the start of contact to 30 msec^{1/2} is set to 1.0 mL/m² or more in the Bristow method by the drying at least a part of the liquid component.
